(19) United States
(12) Patent Application Publication
(10) Pub. No.: US 2006/0151913 A1
(43) Pub. Date: Jul. 13, 2006

(54) Apparatus for and method of lining conduits

(76) Inventor: Neal Deryck Bray Graham, Cockburn Waters (AU)

Correspondence Address: HOGAN & HARTSON LLP, ONE TABOR CENTER, SUITE 1500, 1200 SEVENTEENTH ST, DENVER, CO, 80202, US

(21) Appl. No.: 10/526,027

(22) PCT Filed: Sep. 2, 2003
(86) PCT No.: PCT/AU03/01131

§ 371 Date: Aug. 1, 2005

(30) Foreign Application Priority Data
Sep. 2, 2002 (AU) 2002-951397
Sep. 2, 2002 (AU) 2003902374
Sep. 2, 2003 (WO) AU2003/001131

(51) Int. Cl. B29C 63/30

(52) U.S. Cl. 264/269; 264/40.1; 156/575

(57) ABSTRACT

Apparatus (10) for lining an internal surface of a pipeline (15) or other conduit. The apparatus (10) comprises an installation head (21) which is progressively moved along the pipeline (15) for installing a flexible liner (11) onto the interior surface (13) of the pipeline (15). The flexible liner (11) comprises a tube structure (17) undergoing eversion within the pipeline (15). The tube structure (17) comprises a resin absorbent material. The installation head (21) has a contact surface (23) against which the tube structure (17) acts during eversion thereof, the contact surface (23) having means for delivery of a curable resin to the everting portion of the tube. The installation head (21) advances along the pipeline (15) under the influence of a driving force comprising (at least in part) pressure applied to the installation head (21) through the everting tube structure (17).

### FIELD OF THE INVENTION

This invention relates to an apparatus for, and a method of, lining ducts and other conduits. The invention also relates to a tube structure for use in the apparatus and method.

The invention has been devised particularly, although not solely, for internally lining fluid flow conduits and is applicable to both gravity flow pipelines, such as pipelines for sewer and stormwater drainage, and pressurized pipelines such as water and gas pipelines.

The invention may be used for the renovation of existing pipelines and other conduits in various states of deterioration, with problems ranging from impaired hydraulic performance to partial or complete loss of structural integrity resulting in a total failure to contain the fluids within, or stop the ingression of fluids from without, the pipe. Additionally, the invention may be used to line existing pipelines and other conduits in order to extend the service life thereof. Similarly, the invention may be used to line new pipelines and other conduits in order to provide longevity in terms of service life.

The lining may comprise a continuous layer, or alternatively one or more localised layers, applied within the duct or other conduit.

### BACKGROUND ART

Throughout the world, there are numerous pipelines which are approaching or have exceeded their service life, which have been installed in extreme environments or which were incorrectly installed. Consequently, the pipelines have deteriorated to an extent that remedial action is required in order to maintain their effectiveness or to avoid leakage. This is particularly so for municipal infrastructure involving pipe networks such as sewers and water mains using materials such as vitrified clay (VC) and reinforced concrete (RC). Typical structural problems with such pipe networks include cracking or poor jointing leading to water ingress, sewage egress, root intrusion or calcification build-up on the pipe walls. The structural problems can also include longitudinal cracking and circumferential cracking of pipes within the network, leading to ovality or partial collapse of the pipes.

Systems used for the renovation of such conduits generally fall within three broad categories. The first category involves traditional methods including manually applied liners and cover shotcrete, grouting and placed thermoplastic liners. The second category includes placed thermoplastic liners installed automatically, using materials such as uPVC and HDPE and cover mechanically or thermally expanding the thermoplastic liner against the conduit wall. The third category involves the placement of generally thermoset or catalysed or UV radiation energy cured liners which are typically placed through the eversion of an already resin-impregnated “sock” generally of fibreglass materials. A newer system employs a resin coating on the surface of a flexible tube of aligned polypropylene fibres. The resin on the surface is, upon eversion, forced into the sides of the pipe, the objective being the creation of a bonded liner to the pipe. This does not, in practice, provide a successful consistent bonded liner, as the requirements for the resin layer or thickness varies dependent upon the holes and cracks in the pipe as well as other requirements for the use of the resin in the pipe.

One proposal to line existing pipelines is disclosed in US Pat. 4,687,677 (Jonasson). The proposal involves introduction of a flexible hose-shaped liner containing a curable plastic material into the pipeline to be lined. The flexible liner is introduced into the pipeline in an uncured state and is pressed out against the inside of the pipeline by means of compressed air. The flexible liner is then hardened in place by exposing the curable thermoset resin material to radiation energy. A somewhat similar proposal is disclosed in WO 92/16784 (Lundmark). In this latter proposal, the hose-shaped liner is introduced into the pipeline by either drawing in the liner or by everting the liner into the pipeline.

A disadvantage of such proposals involving installation of a liner which contains a curable resin material and which can be cured upon exposure to radiation energy or heat is that the liner must be manufactured, prepared and stored under fully-controlled conditions at a production facility remote from the installation site and then transported to the installation site. In addition to the transport storage and handling costs involved with storing the liners, there is also the wastage caused by premature curing of the liners in storage. Further, if premature curing is not detected prior to installation, there is the cost of removing the failed liner and commencing the installation again with a new liner. This can contribute significantly to the cost of a pipe lining operation.

There have been various proposals for lining conduits involving installation of a liner as a tube which is everted into the passageway being lined, and which comprises an inner layer of resin absorbent material surrounded by a membrane. As the tube is everted, uncured resin is applied to the everting face of the tube to impregnate the layer of resin absorbent material which is then presented to the surface of the passageway. The everted tube is held in place by fluid pressure until the resin cures to form a rigid lining on the passageway surface. One such proposal is described in GB 1512035.

With lining proposals involving eversion of a tube comprising a layer of resin absorbent material, it is most important for there to be effective impregnation of the resin absorbent material. EP 0 082 212 attempts to address this need by provision of a vacuum inside the tube in order to remove air from the resin absorbent material at the everting face so that such material is in an optimum condition to receive the resin presented to it, thereby ensuring effective penetration of the resin into the absorbent material. However, the method outlined of providing the application of vacuum to the tube is a cumbersome procedure, involving positioning of a vacuum pipe within the tube when it is in a collapsed condition prior to eversion.

Additionally, the resin is presented to the everting face of the tube in the form of a large plug of uncured resin in the passageway to which back pressure is applied. This is employed to support the plug of resin and drive the plug, and the seal within the pipe, forward. Consequently, it is necessary for the everting tube to push the plug of uncured resin along the passageway, with the result that the plug of uncured resin can be under high and variable pressure. The fact that the plug of resin is under high variable and uncontrolled pressure can cause difficulties, one being that ongoing delivery of replenishment resin to the plug can be complicated. Further, as there is no monitoring present, there is no knowledge of the size or consistency of the volume of resin. In particular, there is no feed back to determine if the volume trapped between the everting tube and the seal is air or resin. Also, with an uncontrolled resin “plug”, the air that becomes trapped in the resin volume cannot escape.

It is against this background, and the problems and difficulties associated therewith, that the present invention has been developed.

The reference to prior art in this specification is not, and should not be taken as, an acknowledgement or any form of suggestion that that prior art forms part of the common general knowledge in Australia.

### DISCLOSURE OF THE INVENTION

According to first aspect of the present invention there is provided apparatus for lining an internal surface of a conduit, comprising a body adapted to be progressively moved along the conduit for installing a flexible tube onto the internal surface, the flexible tube undergoing eversion within the conduit, the body presenting a contact surface against which the tube acts during eversion thereof.

The internal surface may comprise an interior wall surface of the conduit or a substrate applied thereto.

The flexible tube structure may be of any appropriate form. In one arrangement, it may for example be of unitary construction comprising a tubular element. In another arrangement, it may for example be of composite construction comprising several layers.

The body may be caused to move along the conduit in any appropriate way, such as for example by application of a driving force thereto. The driving force may involve a towing force applied by way of a towline or pressure applied to the body through the everting tube (arising from the presence of a inflation fluid within the tube), or a combination thereof. Where the body is caused to move by pressure applied through the everting tube, it may be necessary to provide a retarding force to control the rate of advancement of the body. The retarding force may be applied in any appropriate way, such as by a brake sled operably connected to the body and in friction engagement with the interior surface of the conduit.

Preferably, the contact surface has means for delivery of an agent to the everting portion of the tube.

The means for delivery of the agent may include a plurality of ports in the contact surface, the ports communicating with a supply of the agent.

The contact surface may be defined by a plate having apertures therein incorporating the ports.

The plate may be rigidly or elastically supported.

The agent may comprise a curable resin. The curable resin, when applied to a resin absorbent material and allowed to harden, can together with such material provide a composite material forming a rigid structure providing a liner for lining the internal surface.

The conduit may be lined continuously along the length thereof or at least along the length of a longitudinal section thereof, or alternatively at one or more localised areas within the conduit.

Where the internal surface of the conduit is lined continuously for the full length thereof or along at least a longitudinal section of the length thereof, the tube may comprise resin absorbent material. The resin absorbent material may provide the entirety of the tube structure or a portion thereof. Where the resin absorbent material provides a portion of the tube structure, it may be provided as a layer and the tube structure may comprise a further layer, typically in the form of a membrane having characteristics selected according to characteristics required for the lining.

Where the lining is discontinuous in that it is applied to one or more localised areas within the pipeline, the tube structure may comprise a membrane on which are carried one or more liner portions comprising resin absorbent material, the arrangement being that the tube structure upon eversion presents the liner portions to the internal surface of the conduit to provide the localised lining therefor. Typically, the tube structure is subsequently withdrawn, leaving the liner portions in position to provide the localised lining.

Where the tube structure comprises resin absorbent material, such material may be dry or pre-impregnated with resin. In the latter case, it may be either partially or fully impregnated with resin.

According to second aspect of the present invention there is provided apparatus for lining an internal surface of a conduit comprising a body adapted to be progressively moved along the conduit for installing a flexible liner onto the internal surface, the flexible liner comprising a tube structure undergoing eversion within the conduit, the tube structure comprising resin absorbent material, which may be pre-impregnated with resin or not the body presenting a contact surface against which the tube structure acts during eversion thereof, the contact surface having means for delivery of a curable resin to the everting portion of the tube structure.

Where the contact face is defined by a plate, one face thereof may define the contact surface and an opposed face thereof may provide a boundary for a resin chamber from which resin may be delivered to the contact face by way of the apertures therein. This also assists in the rapid and controllable release of any air trapped within the liner. As the air is purged from the highest point within the chamber all the chamber is filled with resin.

With this arrangement, the pressure exerted by the everting tube structure is exerted primarily on the contact surface and not onto the resin itself, and in particular not on the resin contained within the resin chamber. Consequently, the resin can freely flow into contact with the everting tube structure and can be easily replenished by delivery of replenishment resin to the resin chamber. In this embodiment the resin pressure remains generally constant and can thus be controlled through a controlled feed back to resin delivery pumps located typically at a control station at ground level. Typically, replenishment resin is delivered to the resin chamber on a continuous basis during eversion of the tube structure and is controlled with a feed back loop to control feed rate of the everting tube structure and resin pressure for consistent progress along the conduit.

Preferably, the body also has provision for applying resin to the surface onto which the tube structure is presented. As alluded to earlier, the surface to which the tube structure is presented may comprise the interior wall surface of the passageway or a substrate applied to the interior surface of the conduit.

In this regard, the body may comprise a circumferential chamber which is exposed to the internal surface and which contains resin which is wiped on the internal surface. Where the passageway is of circular cross-section, the circumferential chamber is typically of annular configuration.

Preferably, the circumferential chamber is defined between two spaced apart seals and an inner wall extending between the two seals. The outer periphery of the chamber is essentially defined by the surface to which the tube structure is applied.

The seals may comprise wiper seals for sliding and sealing contact with the surface.

The inner wall may be defined by a flexible membrane. The membrane may be deflected for the purposes or pressurising the resin contents within the chamber. Alternatively and/or additionally, the flexible membrane may be vibrated in order to optimise contact of the resin with the surface.

The body may further comprise one or more additional chambers one adjacent another axially spaced along the body.

Each additional chamber may be defined by two seals and an inner wall extending therebetween.

Where there are adjacent chambers, one seal may be common to both of the chambers. In other words, where there are two chambers one leading another with respect to the direction of travel of the body, one seal may function as the trailing seal for one chamber and the leading seal for the other chamber.

Where there are a multitude of chambers, at least some of the chambers may be utilised for the purpose of applying resin to the surface receiving the tube structure. In such a case, the chambers preferably operate at progressively decreasing fluid pressures in the direction away from the everting tube.

The seals may not only perform a sealing function but also function as wiper applicators for applying the resin in a uniform fashion to the internal surface.

The chambers may comprise sealed pressurised chambers between which a differential of pressure can be achieved and maintained, with the highest pressure being exerted in the rearmost chamber wetting the everting tube structure and the lowest in the leading chamber. In this way, purge lines from the rearmost chamber can exhaust into the front chamber driven by the differential in pressure.

In certain circumstances, it may be beneficial to apply a substrate to the conduit prior to the placement of the tube structure to provide the liner. Such substrates may include repair and/or sealing compounds (eg cementitious or polymer grout) or a layer of material for enhancing the engagement of the tube structure with the conduit or the filling of the surface of the inside of the conduit.

The substrate substance can be applied in the same pass as the placement of the everting tube structure. Alternatively, the process may involve placement of the substrate substance first with a removable or sacrificial liner that inflates to hold the substrate substance into position whilst it hardens. Then during a second pass the everting tube structure can be added once the substrate substance has hardened enough to absorb the water and provide a dry surface to allow the resin to cure to it.

Where a substrate is to be applied to the interior surface of the conduit, at least one of the circumferential chambers may be utilised for such a purpose. The or each chamber concerned would be adapted to receive the substrate substance. The substrate substance would be applied to the interior surface of the conduit in a similar fashion to the manner in which resin is applied; that is, the substrate substance would be presented to and wiped onto the interior surface of the conduit. Obviously, the or each chamber utilised in the installation of the substrate would be ahead of the chambers utilised in the delivery of resin for the purposes of bonding the tube structure into position.

Again, the substrate material may be vibrated to optimise deposition of the material onto the interior surface of the conduit.

The body may incorporate a leading section for performing preparatory work on the interior surface of the conduit in order to properly prepare it to receive the substrate substance or resin as the case may be.

The preparatory work may involve removal of dirt and other matter from the surface. For this purpose, the leading section may include circumferential brush devices adapted to brush the interior wall surface of the conduit.

There may be a plurality of the brush devices axially spaced one with respect to another to form air pressure chambers therebetween. A differential pressure gradient may exist between the chambers such that a pressure flow is generated from rearmost chamber to frontmost chamber.

The preparatory work may also involve the application of a preparatory material to the interior surface of the conduit. The preparatory material may comprise a low viscosity adhesive which can be sprayed or otherwise applied.

The forward portion of the apparatus in the preferred embodiment may also incorporate a collection means for collecting debris within the conduit prior to installation of the tube structure to provide the liner. The collection means may comprise a suction system for collecting the debris.

Preferably, the tube structure is delivered to the body in a collapsed condition. With this arrangement, the collapsed tube structure is preferably opened during the eversion process.

The tube structure may have a collapsed condition involving at least one re-entrant fold. Conveniently, there are at least two re-entrant folds one adjacent each longitudinal edge of the collapsed tube structure.

An installation cable (such as a rope) may be provided in the collapsed tube structure for assisting axial movement thereof while in the collapsed condition. Typically, the cable is used to haul the collapsed tube structure axially. Interaction between the installation cable and the collapsed tube structure may arise through a binding action therebetween as a consequence of the tube structure being collapsed about the cable. The cable may progressively separate from the tube structure as the latter everts.

The body may be provided with means to establish a “wet-out” region within the collapsed tube structure prior to eversion thereof for the purposes of increasing the effectiveness of resin penetration.

This may involve a lance structure projecting outwardly of the contact surface and terminating at a free end, with the collapsed tube structure embracing the lance structure so that the lance structure is inserted in the tube structure as it approaches the contact face for eversion thereagainst.

The free end of the lance structure may be configured to spread the collapsed wall of the tube structure to create a cavity to receive the resin.

To do this reliably, it is preferred to further include means to monitor and/or control the speed of progress of the body and the volume/thickness of resin applied to the conduit and the everting tube structure. Such means may be part as a quality control system upon which the body may react, or communicate to a remote operator who may provide remote control or through a remote feed back loop to the pressure control to the pumps and the liner pull to vary the speed of advance. This can also control the feed pressure for the resin injection into the everting tube structure and the inflation pressure of the pressure chamber and the tube structure as well as the vacuum on the tube structure. In this way, the apparatus can be self controlling to ensure the optimum rate of progress is maintained. This can then be plotted and the plot provided to the customer.

The lance may incorporate an axial passage for receiving the installation cable as it separates from the tube structure during eversion thereof.

The apparatus may further include a temperature measurement device for monitoring the temperature of the conduit/liner which may be in communication with a remote operator. There may also be a feed back loop with the resin supply to control the amount of catalyst to resin ratio to suit it to the temperature and conditions within the pipe. This may also form part of the quality control system.

Preferably, the apparatus further includes means for sensing and/or monitoring selected conditions associated with installation of the liner and varying the installation process as necessary having regard to such conditions. Such conditions may include the delivery rate and composition of the resin, loadings on the everting tube and the surface condition of the conduit.

According to a third aspect of the invention there is provided a method of lining conduits utilising apparatus according to the first or second aspects of the invention as set forth above.

According to a fourth aspect of the present invention there is provided a method of lining a conduit comprising: providing a tube structure as a liner for the conduit, everting the tube structure into the conduit whereby the tube structure has an inner tube portion, an outer tube portion and an everting portion extending between the inner and outer tube portions; causing the exposed face of the everting portion of the tube structure to slidably engage a contact surface at which a curable resin is presented to the everting face for impregnation thereof.

Preferably, the method further comprises sensing and/or monitoring selected conditions associated with installation of the liner and varying the installation process as necessary in response to such conditions.

According to a fifth aspect of the invention there is provided a tube structure characterised in that the tube structure has a collapsed condition involving at least one re-entrant fold formed therein and extending longitudinally thereof.

### BRIEF DESCRIPTION OF THE DRAWINGS

The invention will be better understood by reference to the following description of several specific embodiments thereof as shown in the accompanying drawings in which:

FIG. 1 is a schematic sectional view of apparatus according to a first embodiment in operation installing of a liner in a pipeline;

FIG. 2 is a fragmentary sectional side view of the apparatus installing the liner in the pipeline;

FIG. 3 is a fragmentary perspective view of the apparatus installing the liner in the pipeline;

FIG. 4 is a fragmentary sectional view of the trailing end of the installation head;

FIG. 5 is a fragmentary sectional view of an intermediate part of the installation head;

FIG. 6 is a fragmentary sectional view of the leading part of the installation head;

FIG. 7 is a fragmentary sectional side view illustrating a wiper seal forming part of the installation head, with the wiper seal being shown in a normal condition;

FIG. 8 is a view similar to FIG. 7 with the exception that the wiper seal is shown in a deflected condition;

FIG. 9 is a schematic cross sectional view of a tube structure which provides the liner, the tube being shown in a collapsed condition;

FIG. 10 is a fragmentary sectional view of the trailing end of an installation head of apparatus according to a second embodiment;

FIG. 11 is a fragmentary sectional view of the trailing end of the installation head of apparatus according to a third embodiment;

FIG. 12 is a fragmentary sectional side view of the trailing end of the installation head of apparatus according to a fourth embodiment; and

FIG. 13 is a view somewhat similar to FIG. 12 with the exception that a suction line within the installation head is shown in an extended condition;

FIG. 14 is a fragmentary perspective view of apparatus according to a fifth embodiment;

FIG. 15 is a perspective view, shown partly cut-away, of a delivery chamber forming part of the apparatus shown in FIG. 14, with the collapsed tube structure shown passing therethrough;

FIG. 16 is a sectional side view of the delivery chamber shown in FIG. 15;

FIG. 17 is a fragmentary view of the apparatus shown in FIG. 14, illustrating guide rollers for guiding the collapsed tube structure;

FIG. 18 is a cross sectional view of a delivery chamber for apparatus according to a sixth embodiment;

FIG. 19 is a fragmentary elevational view of apparatus according to a seventh embodiment;

FIG. 20 is a schematic view of a sealing clamping seal mechanism used with the apparatus shown in FIG. 19;

FIG. 21 is a schematic view of a suction line incorporated in the apparatus shown in FIG. 20, with the suction line being shown in a retracted condition;

FIG. 22 is a view similar to FIG. 21, with the exception that the suction line is shown in an extended condition;

FIG. 23 is a schematic end view of a brake slide structure forming part of the apparatus shown in FIG. 20;

FIG. 24 is a view similar to FIG. 23, with the exception that the brake slide structure is shown on a somewhat larger scale;

FIG. 25 is a side elevational view of the brake slide structure;

FIG. 26 is a schematic side elevational view of apparatus according to an eighth embodiment;

FIG. 27 is a fragmentary perspective view of the apparatus shown in FIG. 26 installing a liner in the pipeline;

FIG. 28 is a fragmentary side elevational view of the trailing end of the installation head of the apparatus shown in FIG. 26;

FIG. 29 is a view similar to FIG. 28, illustrating the apparatus installing a liner without use of a installation cable;

FIG. 30 is a schematic cross sectional view of a tube structure for use with apparatus according to any of the previous embodiments, the tube structure being in a collapsed condition having two opposed re-entrant folds;

FIG. 31 is a schematic view illustrating the everting end of the collapsed tube structure shown in FIG. 30;

FIG. 32 is a schematic view illustrating, for comparison purposes, the everting end of a collapsed tube structure of the type illustrated in FIG. 9 of the first embodiment;

FIG. 33 is a schematic cross sectional view of a further version of the tube structure in a collapsed condition having a plurality of opposed re-entrant folds;

FIG. 34 is a schematic cross sectional view of a still further version of collapsed tube structure;

FIG. 35 is a schematic cross sectional view illustrating the tube structure of the type shown in FIG. 34 installed within a pipeline to provide a lining therefor;

FIG. 36 is a schematic cross sectional view of apparatus used for delivery of the tube structure shown in FIG. 34 to a pipeline;

FIG. 37 is a schematic elevational view of a production system for manufacturing a tube structure of the type shown in FIG. 30;

FIG. 38 is a schematic view of a former used in the system illustrated in FIG. 37;

FIG. 39 is a schematic view illustrating construction of an inner layer of the tube structure;

FIG. 40 is a view illustrating the inner layer folding about the former;

FIG. 41 is a schematic view illustrating construction of an outer layer about the inner layer to provide the tube structure;

FIG. 42 is a view illustrating the former being used to assemble the outer layer of the tube structure about the inner layer;

FIG. 43 is a schematic plan view of a folding mechanism for performing a folding operation on the tube structure;

FIG. 44 is a schematic plan view of an inner former forming part of the folding mechanism;

FIG. 45 is a schematic end view of the inner former;

FIG. 46 is a schematic plan view illustrating the folding mechanism in operation to subject the tube structure to a folding operation;

FIG. 47 is a schematic view illustrating construction of an inner layer of the tube structure with an installation cable therein;

FIG. 48 is a view illustrating the former being used to introduce the installation cable into the inner layer of the tube structure during construction thereof;

FIG. 49 is a schematic cross sectional view of an assembly of umbilicals used for delivery of services to the installation head of apparatus according to any of the earlier embodiments, the assembly of umbilicals being contained within a containment sleeve; and

FIG. 50 is a schematic elevational view illustrating assembly of the umbilicals and positioning of the containment sleeve therearound.

### BEST MODES(S) FOR CARRYING OUT THE INVENTION

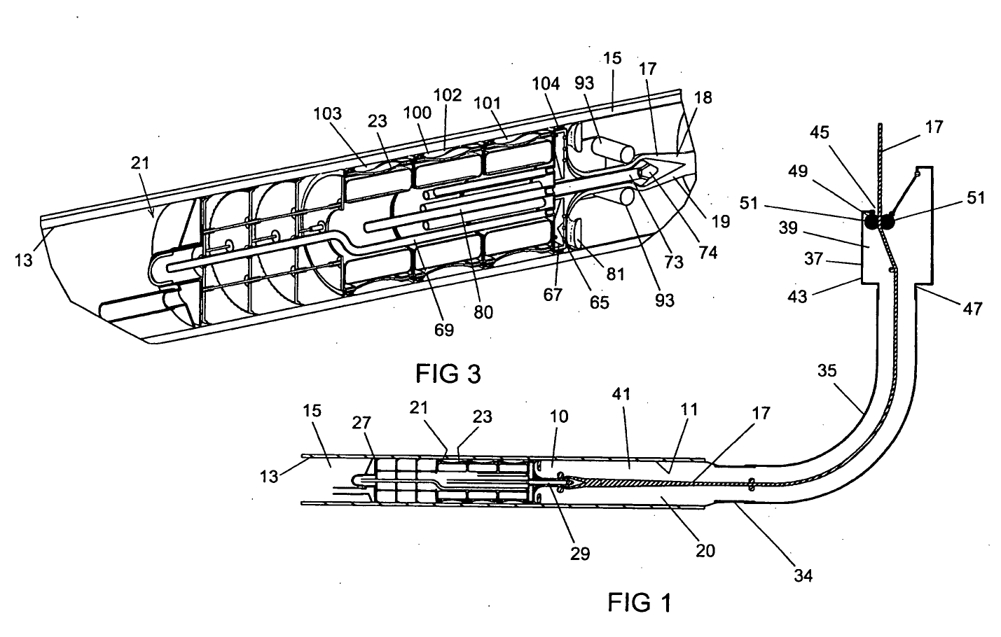

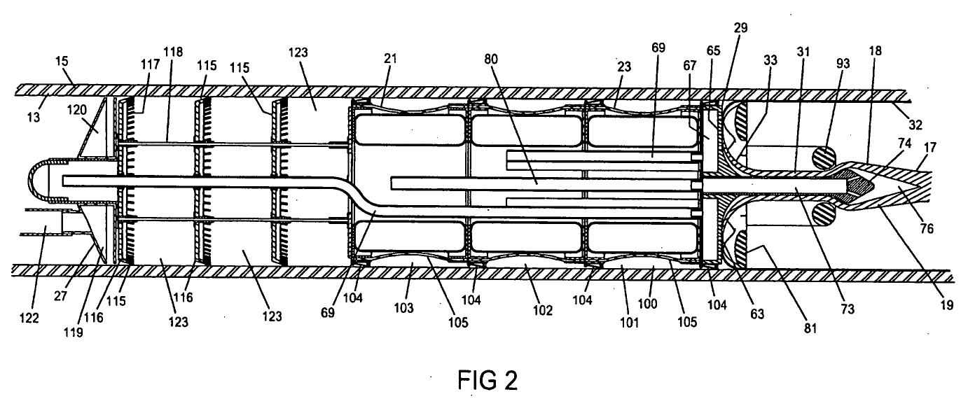

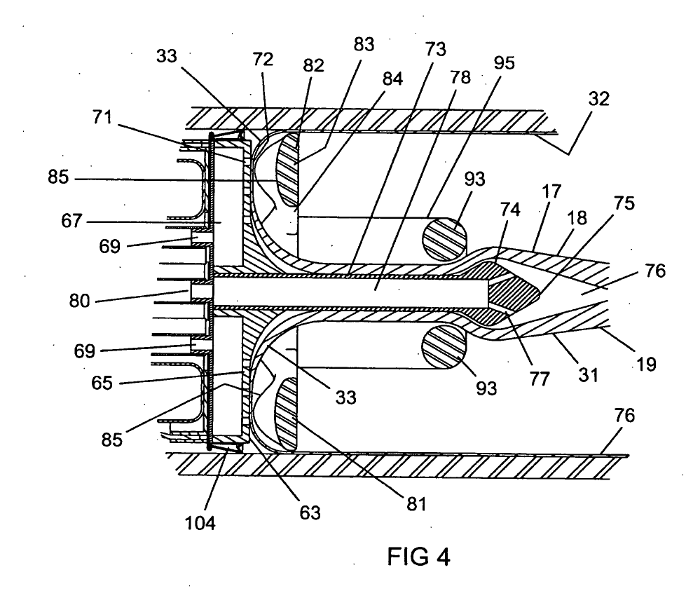

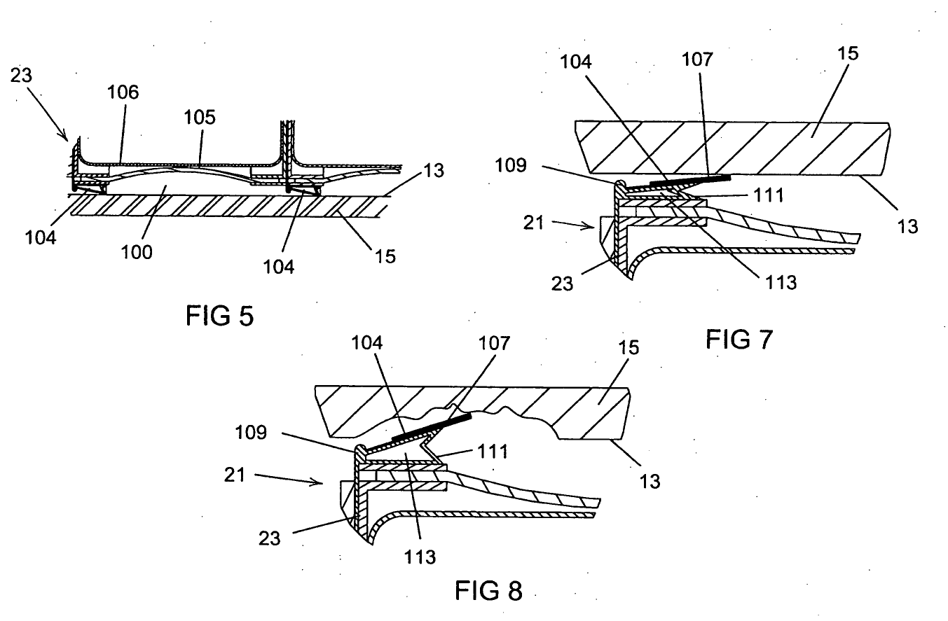

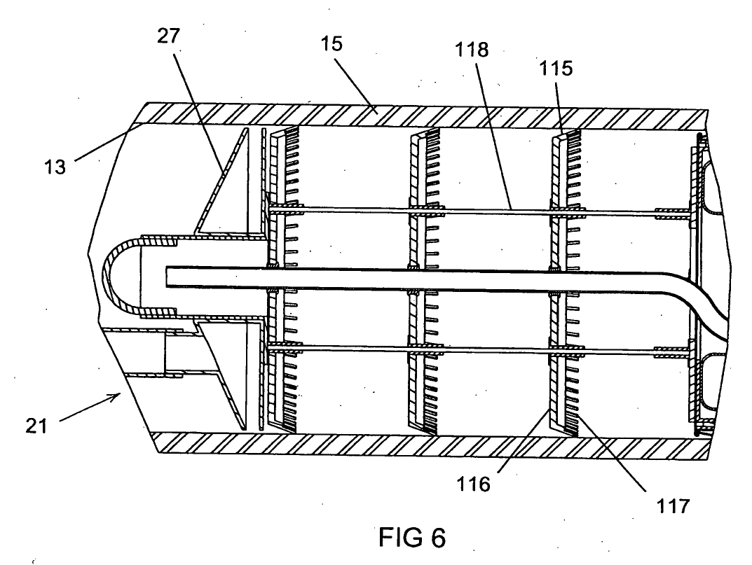

Referring to FIGS. 1 to 9 of the accompanying drawings, there is shown apparatus 10 according to a first embodiment for installing a liner 11 onto the interior surface 13 of a pipeline 15. The liner 11 provides a hermetically sealed barrier that is resistant to both corrosion and wear.

In this embodiment, the liner 11 is in the form of an everted tube structure 17. Prior to eversion, the tube structure 17 comprises a first tubular layer 17a of a resin absorbent material such as fibreglass fabric fully or partly impregnated, or dry and a second tubular layer 19 providing a membrane. Prior to eversion of the tube structure 17, the first layer 17a is innermost and the second layer 17b is outermost to surround the first (inner) layer. The membrane material providing the second (outer) layer 17b is selected according to the demands placed on the liner 11 within the pipeline 15. For example, where abrasion and wear resistance is required, the second layer 17b may be formed of polypropylene. In other cases, the second layer 17b may be formed of polyester (Mylar), nylon urethane rubber or other material appropriate for the intended application.

Upon eversion, the first layer 17a is turned outwardly and presented to the interior surface 13 of the pipeline 15. As will be explained in detail later, a curable resin is applied to the first layer 17a prior to its application onto the interior surface 13 of the pipeline 15. An inflation fluid is delivered into the interior 20 of the everted portion of the tube structure 17 to maintain the tube structure in intimate contact with the interior surface 13 of the pipeline 15 until the resin has cured, whereupon the resin and fibreglass fabric combine to provide a rigid composite structure which lines the pipeline 15, with the second layer 17b, which provides the membrane, being on the inner face of the composite structure and in contact with subsequent fluid flow along the pipeline.

The curable resin may comprise an epoxy, vinyl, polyester or acrylic resin such as methyl methacrylate. The curable resin may be aerated in certain applications.

The apparatus 10 comprises an installation head 21 which is movable along the pipeline and which includes a body 23. The installation head 21 is adapted to be progressively moved along the pipeline 15 during installation of the liner 11.

The body 23 has a leading end 27 and a trailing end 29. In this embodiment, the body 23 is adapted to be pulled through the pipeline 15 by way of a tow line (not shown) connected to the leading end 27 and extending to a station (not shown) located exteriorly of the pipeline.

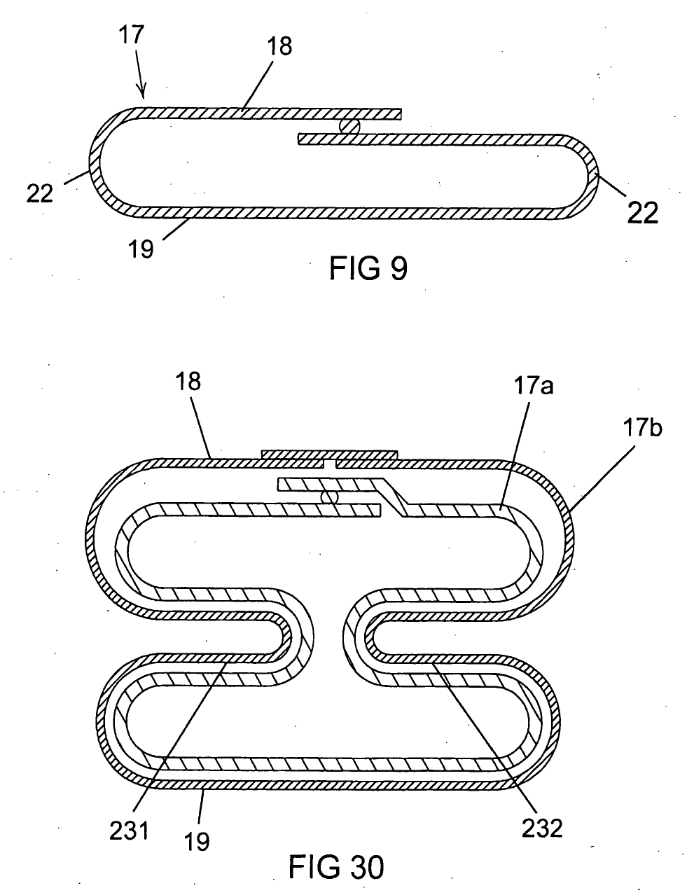

The tube structure 17 is delivered to, and pulled along, the pipeline 15 in a flattened or collapsed condition and is everted from that condition, as best seen in FIG. 1 of the drawings. In the flattened or collapsed condition, the tube structure 17 has two opposed longitudinal side portions 18, 19 and folds 22 therebetween, as shown in FIG. 9. In FIG. 9, the two longitudinal side portions 18, 19 are shown spaced apart, for the purposes of clarity in the drawing. In practice, the two portions 18, 19 would be in facing contact with each other.

With eversion of the tube structure 17, there is created an inner tube portion 31 and an outer tube portion 32, with the two portions 31, 32 being joined by the everting portion 33.

One end of the tube structure 17 is attached to a rigid installation duct 34 positioned adjacent the inlet end of the pipeline 15. Typically, the tube structure 17 is connected to one end of the duct 34 by way of a clamping collar (not shown) which extends around the tube and sealingly connects it to the end of the duct.

A delivery duct 35 extends between the installation duct 34 and a delivery structure 37 which incorporates a delivery chamber 39. The delivery duct 35 comprises a flexible hose structure which is inflated to provide the duct. An inflation chamber 41 is created through the combination of the interior 20 of the everted tube structure 17, the installation duct 34, the delivery duct 35 and the delivery chamber 39. An inflation fluid (such as air) is introduced into the inflation chamber 41 so as to urge the everted tube structure 17 outwardly in order to position it in contact with the interior surface 13 of the pipe 15 to which it is bonded while the resin applied thereto sets.

The inflation fluid is introduced into the inflation chamber 41 by way of the delivery chamber 39 at the inlet end of the duct 35. The delivery chamber 39 is defined by a housing 43 having an entry end 45 and an outlet end 47 which communicates with the duct 35. The entry end 45 of the delivery chamber 39 is closed to maintain inflation pressure in the chamber, there being provided a fluid seal mechanism 49 in the entry end 45 to allow entry of the collapsed tube. The fluid seal mechanism 49 comprises a pair of sealing rollers 51 positioned in side-by-side relationship to receive the collapsed tube structure therebetween. The sealing rollers 51 are resiliently deformable for the purpose of establishing good sealing contact with the tube structure 17.

The inflation pressure causes the tube structure 17 to evert as the installation head 21 moves along the pipeline 15.

The installation head 21 has a contact face 63 at the trailing end thereof against which the tube structure 17 everts. The contact face 63 is configured to conform to, and guide, the everting portion 33 of the tube structure 17 as it turns between the inner tube portion 31 and the outer tube portion 32. The contact face 63 is defined by a pressure plate 65. A resin chamber 67 is located in the body 23 adjacent the pressure plate 65. The pressure plate 65 provides a boundary for the resin chamber 67 and separates the resin chamber from the everting tube structure 17. Resin delivery lines 69 are provided for delivering the curable resin from a source (not shown) to the resin chamber 67.

A plurality of apertures 71 are provided in the pressure plate 65, the apertures 71 extending from the resin chamber 67 and opening onto the contact face 63 by way of ports 72 incorporated in the contact face 63. With this arrangement, the everting tube structure 17 wipes over the contact face 63 and so is exposed to resin delivered from the resin chamber 67. The resin from the resin chamber 67 also flows into the space 68 bounded by the pressure plate 65 and the everting tube structure 17 to ensure that the everting tube structure is fully exposed to the resin, and travels back down the tube structure to fill and wet the tube structure as it approaches the pressure plate 65.

A lance structure 73 projects rearwardly from the pressure plate 65 and terminates at a protrusion 74 which is received in the collapsed interior of the tube structure 17 between side portions 18, 19 as the tube approaches the installation head 21. The protrusion 74 is of bulbous configuration and incorporates a rounded nose 75 which is presented to the oncoming collapsed tube structure 17. The protrusion 74 serves to expand the collapsed tube wall to create a cavity 76 into which resin is delivered by way of delivery ports 77 incorporated in the nose 75 and communicating with a central bore 78 in the lance structure 73. The interface between the protrusion 74 and the tube structure 17 sliding thereover, provides a seal therebetween. The central bore 78 receives resin from the resin supply by way of delivery line 80. The design of the lance structure 73 is such as to provide a base attached to the pressure plate 65 of small circumference and the protrusion 74 of a larger circumference. In this way, the lance structure 73 follows the general shape formed by the tube structure as it is everting, with the everting face itself being the point of highest pressure and the area just before the everting face being a point of low pressure. Therefore, it is easier to form a cavity just behind the everting face. The cavity 76 into which the resin is delivered creates a “wet-out chamber” within the collapsed tube structure 17 for the purposes of initially presenting resin to the tube structure. The objective is the creation of a long “wet-out” chamber by the hydraulic force of the resin bulging the everting tube structure 17. The length and size of the wet-out chamber can be controlled by the resin injection pressure and the inflation pressure within the everting tube structure 17. The balance to be achieved is the length of the wet-out chamber and the wet-out rate. The longer the wet-out chamber, the longer time the resin is exposed to the fibreglass the faster the rate of progress.

In the embodiment, the separation of the resin chamber 67 from the force of the everting tube structure 17 driving and pressing against the rear of the installation head 21 means that the resin pressure need only be enough to fill the depth of the chamber and that this is consistent and can be monitored. Also the content of resin in the chamber can be monitored in various means to ensure that all air is purged from the resin volume.

In this embodiment, the installation head 21 further includes a guide structure 81 about which the tube structure 17 passes as it everts. The guide structure 81 comprises a guide ring 82 having a ring body 83 with a central opening 84 therein. The ring body 83 presents a guide surface 85 about which the tube structure 17 turns, with the inner tube portion 31 entering the ring body 83 through the central opening 84 and the everting portion 33 passing around the guide surface 85 such that the outer tube portion 32 leaves from the outer periphery of the ring body.

The guide structure 81 may be configured to avoid, or at least reduce, the tendency for formation of wrinkles and folds in the tube structure 17 as it everts. In this regard, the guide structure may comprise a guide ring structure of the configuration disclosed in PCT/AU01/00563 (WO 01/88338).

The guide structure 81 serves to present the tube structure 17, and in particular first layer 17a of fibreglass fabric, to the contact face 63 for exposure to, and impregnation by, the resin.

The guide structure 81 moves with the body 23 as a result of interaction between the protrusion 74 and rollers 93 mounted on a support structure 95 extending rearwardly from the ring structure, with the wall of the tube structure 17 passes through the gap 97 between the rollers and the protrusion 89. Consequently, a pulling force applied to the body 23 by way of the tow line is transmitted to the guide structure 81 so that it moves in unison with the body 23 by interaction between the protrusion 74 and the rollers 93.

The body 23 incorporates a plurality of holding chambers 100 disposed axially there along. In this embodiment, there are three such holding chambers 101, 102 and 103.

Each chamber 100 is defined between two spaced apart annular wiper seals or inflatable spreaders 104 and an inner wall 105. The outer periphery of each chamber 100 is exposed directly to the interior surface 13 of the pipeline 15.

Each inner wall 105 is of flexible construction and can be subjected to vibration for the purposes of pressurising contents of the chamber in a pulsating fashion.

An inflatable bladder 106 is associated with each inner wall 105, as best seen in FIG. 5 of the drawings. Introduction and extraction of inflation fluid with respect to the inflatable bladder 105 can be used to generate pulsations in the inner wall 105. Furthermore, the volume of the respective chamber 105 can be varied by selective movement of the inner wall 105 under the influence of the inflatable bladder 106.

In this embodiment, each chamber 100 is adapted to receive resin from the resin supply or grout form the grout supply for the purposes of depositing a layer of resin or grout onto the interior surface 13 of the pipeline 15 prior to application of the liner in position. This further ensures that there is adequate resin for the purpose of wetting out the fibreglass fabric 17a.

A particular feature of the flexible wall 105 defining each chamber 101 is that the volume of the chamber can be varied and thus regulated, as alluded to above. This is advantageous in that the volume of any one or more selected chambers 100 can be decreased as the installation head 21 approaches the end of the pipeline, thereby ensuring that there is little or no remnant resin in the chamber at the end of the installation process. The presence of remnant resin or grout can cause difficulties in that it can spill or otherwise be wasted.

The chambers 100 operate at different resin pressures; for example, chamber 101 has a higher resin pressure than chamber 102 which in turn has a higher resin pressure than chamber 103. The progressively decreasing resin pressure extending from chamber 101 down to chamber 103 reduces the likelihood of resin leakage from the installation head 21. Any leakage from chamber 101 (which is at the highest resin pressure) can either be rearwardly towards the everting tube structure 17 (where resin is required in any event) or forwardly into chamber 102 (which is at reduced pressure relative to chamber 101). Similarly, any leakage from chamber 102 can either be rearwardly to chamber 101 (which is unlikely owing to the higher pressure in chamber 101) or forwardly to chamber 103 which is at reduced pressure compared to chamber 102. Because chamber 102 is at a reduced pressure, there is little likelihood of leakage from that chamber. If, however, there is leakage from chamber 102 it is unlikely to be of any consequence as it would simply be leakage which deposits resin onto the interior surface 13 of the pipeline 15 where it is required in any event.

The annular seals 104 each comprise a seal face 107 pivotally connected at hinge 109 to the body 23. The seal face 107 is of annular configuration, as is the hinge 109. The hinge 109 is typically a film hinge.

The seal face 107 is incorporated in an annular seal body 111 which also incorporates an annular inflation chamber 113. The seal face 107 comprises bristles which are forced outwardly for sliding and sealing engagement with the interior surface 13 of the pipeline 15 upon inflation of chamber 113 as the installation head 21 moves along the pipeline. Because the seal face 107 is biased outwardly, it can follow irregularities in the interior surface 13 of the pipeline. When the inflation chambers 113 are deflated, the seals 104 can collapse inwardly so moving the seal faces 107 away from the interior surface 13 of the pipeline. This is particularly advantageous during initial insertion of the installation head 21 into, and removal of the installation head from, the pipeline 15. Because the seals 104 are retracted, they do not engage the interior surface 13 of the pipeline 15 and thus facilitate ease of travel along the pipe when not in operation and during insertion and removal of the installation head 21. This allows the process to be performed without interference which otherwise might occur through engagement of the seals 104 with the interior surface 13 of the pipeline 15. Once the installation head 21 is in position in the pipeline 15, the various chambers 113 can be inflated so as to move the seal faces 107 into sealing engagement with the interior surface 13 of the pipeline 15.

The wipe seals 104 extend rearwardly and outwardly with respect to the direction of travel of the installation head 21, as is apparent from the drawings. With this arrangement, the wiper seals 104 are biased outwardly into sealing engagement with the interior surface 13 of the pipeline under fluid pressure within the respective chambers 100 to which the wiper seals are exposed. This is particularly advantageous in relation to the particular wiper seal confronting the resin chamber 67, as the resin pressure therein serves to urge the wiper seal outwardly into sealing engagement with the interior surface of the pipeline.

While the seal and spreader faces 107 have been described as being in sliding and sealing engagement with the interior surface 13 of the pipeline, it should be understood that they are more likely to be in sliding and sealing engagement with a layer of resin or grout applied to the interior surface. The seal faces 107 are utilised not only to perform a sealing function but also to perform a wiping or spreading function by applying resin to the interior surface 13. Accordingly, it is necessary for the seal faces 107 to accommodate the film of resin.

In this embodiment, the holding chambers 100 comprise three chambers 101, 102 and 103. It will be appreciated that any appropriate number of chambers can be employed, as necessary. It is particularly advantageous for there to be a multitude of chambers 100, such that there is ample resin available to fill defects such as cracks and cavities in the interior surface 13 of the pipeline 15, with the series of chambers progressively filling the defects as they pass over them upon movement of the installation head 21 through the pipeline.

The installation head 21 may further comprise a series of axially spaced brush devices 115 positioned behind the leading end 27 of the body 23. Each brush device 115 comprises an annular base 116 with bristles 117 projecting therefrom for brushing engagement with the interior surface 13 of the pipeline 15. The brush devices 115 are linked one to another by way of flexible cables 118. The brush devices 115 are intended to remove debris from the interior surface 13 of the pipeline 15 in order to prepare the surface to receive resin for bonding the liner 11 in position.

A series of chambers 123 are defined between the brush devices 115. The chambers 123 are adapted to contain air at differential pressure such that the air in the trailing chamber is at the highest pressure and the leading chamber at the lowest pressure, with the pressure in the intervening chamber being at an intermediate level such that there is a progressive increase in air pressure from the trailing chamber to the leading chamber. With this arrangement, a flow of air can be generated forwardly from one chamber to the next in the event a fault in the pipeline 15 allows air to leak from one chamber to the next. In the process of moving from one chamber to the next, the air flow will dislodge debris such as sand and gravel particles and displace water resting in any cavities of the pipeline 15 by either blowing it out in front of the installation head 21 for collection or, if there is a hole in the pipeline 15, by displacing the water and debris through the hole to the outside of the pipeline. In this way, the apparatus 10 can also operate in a pipe that is under the water table by displacing the water by air pressure.

The installation head 21 may further include a collection means 119 for collecting debris within the pipeline 15 prior to installation of the liner 11. The collection means 119 comprises a suction system having a suction head 120 connected to a suction line 122.

Means (not shown) may also be provided for spraying a low viscosity adhesive onto the interior surface 13 for absorption therein prior to placement of the liner 11.

The apparatus 10 can be equipped with various sensing and monitoring devices to facilitate regulation of the installation process for the liner 11, with the objective of establishing and maintaining optimum conditions therefor. Such sensing and monitoring devices may include means for conducting visual inspections of the pipeline 15 prior to, during, and/or after the installation process. Additionally, such devices may permit a determination to be made as to the extent (if any) of cleaning required for the pipeline surface.

Further, such devices may enable calculation of the optimum volumetric quantities and delivery rates for the resin. In this way, delivery of the resin can be controlled to allow application of appropriate quantities. Thus, the delivery rates (and hence volume) of resin can be regulated on an ongoing basis during the installation process where, for example, it may be necessary to apply more resin at some locations than at other locations because of variations in the pipeline condition along its length. As well as avoiding wastage of resin, this may also allow the installation speed to be increased at locations where reduced resin quantities are required.

Still further, the sensing and monitoring devices may allow optimum curing conditions for the resin to be determined, having regard to factors such as, for example, temperature and humidity. This may permit the composition of the resin to be varied as necessary in an endeavour to provide optimum curing conditions, by for example adding, removing or varying the quantity of components such as accelerators, activators and/or catalysts.

Other sensing and monitoring devices may include sensors for measuring the strain and load on the everting liner.

The use of the sensing and monitoring devices facilitates ongoing, or at least regular, feedback for maintenance of optimum installation conditions. This enhances the reliability of the installation process.

The installation head 21 is of articulated construction so that it can negotiate contours and bends within the pipeline. The flexible nature of the cables 118 extending between the brush devices and sliding seals spreaders and scrapers 115 facilitates the articulated construction of the installation head 21.

Operation of the apparatus 10 installing the liner 11 in the pipeline 15 will now be described.

The installation head 21 is positioned within the pipeline 15 adjacent the end thereof at which the lining operation is to commence. The leading end 27 of the body 23 is connected to a tow line which extends to the other end of the pipeline and terminates at a station at which various operations are performed including retraction of the tow line in order to pull the installation head 21 along the pipeline. The installation duct 34 is positioned adjacent the commencement end of the pipeline 15 and the delivery structure 37 is installed at a convenient location, typically at ground level in the vicinity of the end of the pipeline. The delivery duct 35 is then positioned between the installation duct 34 and the delivery structure 37. Because of its flexible nature, the delivery duct 35 can conveniently follow an access path dug in the ground leading to the end of the pipeline. The tube structure 17 is then passed in a collapsed condition through the entry end 45 of the delivery chamber 39 within the delivery structure 37 and along the delivery duct 35 to project beyond the installation duct 34. The leading end of the collapsed tube structure 17 is then connected to the installation duct 34 by way of a clamping collar which extends around the tube and sealingly connects it to the end of the duct 34. Fluid pressure is then introduced into the delivery chamber 39 and the delivery duct 35, so as to inflate the delivery duct 35 and commence eversion of the tube structure 17. The fluid pressure is generated by introduction of an inflation fluid, typically air. As the tube structure 17 commences to evert, its everting portion 33 is presented to, and guided into the end of the pipeline 15 so that the tube structure advances along the pipeline as it everts.

As the everting tube structure 17 advances along the pipeline 15, it embraces the lance structure 73, and the everting portion 33 engages the pressure plate 65 at the trailing end of the body 23. The rate of advancement of the everting tube structure 17 along the pipeline 15 is controlled by the rate at which the installation head 21 itself travels, with the everting face 33 of the tube structure 17 being in wiping contact with the contact face 63. Because the contact pressure exerted by the everting tube structure 17 is directed primarily onto the pressure plate 65, the resin itself can flow freely through the apertures 71 and into the space bounded by the pressure plate 65 and the everting portion 33 of the tube structure 17. Resin within the resin chamber 67 passes through the apertures 71 in the pressure plate 65 and so contacts the everting portion of the tube structure 17 to impregnate the fibreglass layer thereof. The fibreglass layer 17a is also wetted with resin through exposure to resin at the nose 75 of the lance 73. As the installation head 21 advances along the pipeline 15, resin is applied to the interior surface 13 of the pipeline by way of the chambers 100. The wiper seals 104 function as wipers or scrapers for spreading the resin in a uniform fashion on the interior surface 13.

Because of the various locations at which resin is presented to the fibreglass layer 17a of the tube structure 17 by the time it contacts the interior surface 13 of the pipeline 15, optimum resin impregnation of the fibreglass fabric is achieved.

Inflation pressure within the everting tube structure 17 presses the outer portion 32 of the tube structure 17 into intimate contact with the interior surface 13 of the pipeline 15. The process continues until the installation head 21 reaches the other end of the pipeline 15, where it can be withdrawn from the pipeline and the surplus end section of the tube structure 17 clamped to the pipeline 15 so as to close the end of the inflation chamber 41 and thereby maintain inflation pressure within the everted tube structure 17 until such time as the resin sets to form a composite structure in co-operation with the fibreglass fabric.

It is desirable to avoid spillage of resin once the installation head 21 reaches the end of the pipeline 15, as such spillage can be both messy and wasteful. With a view to avoiding, or at least reducing, resin spillage, the supply of resin to the resin chambers 100 can be regulated as the installation head 21 approaches the end so that only the necessary quantity of resin is contained within the chambers and there is little or no surplus resin remaining on arrival at the pipeline end.

The surplus end section of the tube structure 17 may be clamped in any appropriate way. One particularly suitable way involves a clamp structure (not shown) having a base and a flexible clamping strap attached at one end thereof to the base. The clamping strap can be configured into a loop around the surplus end section of the tube structure and the opposite end of the clamping strap connected to a mechanism mounted on the base and operable to cause constriction of the loop. The mechanism may, for example, comprise a winding mechanism about which the strap can be wound.

Such a clamp structure provides a simple yet highly effective clamping arrangement. All that is required is to loop the strap around the tube structure end section, connect the free end of the strap to the winding mechanism, and then operate the mechanism to cause constriction of the loop and thus clamping of the tube structure.

It is a feature of the apparatus 10 that a mass of resin is constrained within the resin chamber 67. In particular, the mass of resin is constrained at one end thereof by the body 23 where it confronts a resistive force presented thereby. The mass of resin is also constrained at the other end thereof by the everting portion 33 of the tube structure where it is exposed to a pushing or driving force presented thereby. In other words, the mass of resin is constrained by forces exerted on it by the body 23 and the everting tube structure 17. Such forces act on the mass of resin such that it is in effect a column of resin ahead of the everting tube structure 17.

In this embodiment, the wiper seals 104 perform both sealing and resin spreading functions. It should be understood that such functions can be performed by separated elements, if desired. For example, a mechanical trowel may be provided to perform, or assist in performing, the spreading function.

In the first embodiment, there was a mechanical connection between the body 23 and the guide structure 81 by virtue of interaction between the protrusion 74 and rollers 93 for the purposes of moving the guide ring structure 81 along the pipeline 15 in unison with the body 23.

In an alternative arrangement, there is may be an electromagnetic connection between the body 23 and the guide structure 81 for such purpose. The electromagnetic interconnection may be the sole connection therebetween or it may be augment a mechanical connection of any appropriate type such as that described in relation to the first embodiment.

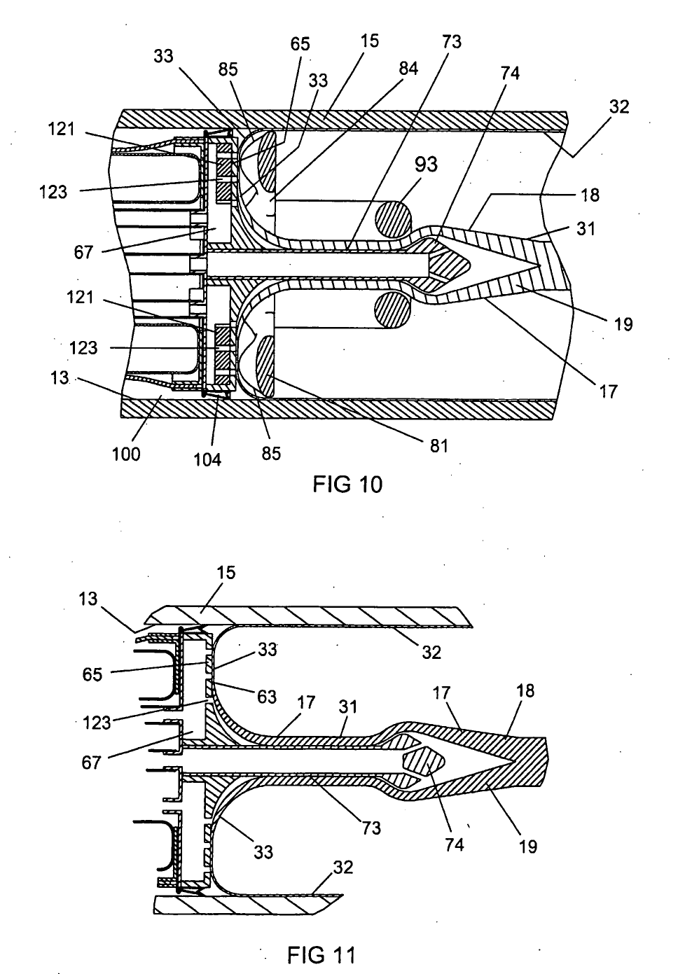

The second embodiment, which is illustrated in FIG. 10 of the drawings, uses an electromagnetic connection between the body 23 and the guide structure 81. The electromagnetic connection comprises an electromagnet 121 positioned on the pressure plate 65 on the side thereof opposite the contact face 63. With this arrangement, the electromagnet 121 is accommodated within the resin chamber 67. The electromagnet 121 incorporates apertures 123 which align with corresponding apertures 71 in the pressure plate 65 so as not to interfere with flow of resin from the resin chamber 67 to the contact face 63.

A particular advantage of the electromagnetic connection is that the gap between the contact face 63 and the guide surface 85 of the guide structure 81 can be selectively varied by virtue of the intensity of the magnetic field which is established. In this way, the drag imposed on the tube 13 by the installation head 21 as it advances along the passageway 15 can be regulated. This information can be incorporated into a direct feed back loop so that the process and the thickness of the resin contained between the face and the ring can be controlled.

In this embodiment, the installation head is equipped not only with the electromagnetic connection but also the mechanical connection provided by interaction between the rollers 93 supported on the guide structure 81 and the protrusion 73 provided on the lance 73 projecting rearwardly from the body 23. In this way, the connection between the guide ring 81 and the body 23 is maintained even when the electromagnetic connection ceases.

In the first and second embodiments, the tube structure 17 everts around a guide structure 81. It should, however, be appreciated that the guide structure may not be necessary in certain applications. The action of fluid pressure within the everting tube structure 17 may be sufficient to cause eversion of the tube structure and to advance the tube structure along the pipeline. The rate of advancement of the everting tube along the pipeline is controlled by the rate at which the installation head 21 itself travels, with the everting face 33 of the tube structure 17 being in wiping contact with the contact face 63. Such an embodiment is illustrated in FIG. 11 of the drawings.

In this embodiment, the tube structure 17 is not physically connected to the installation head 21 in a manner whereby it can be drawn along by the installation head. Rather, the tube structure 17 merely bears on the installation head through contact therewith at the contact face 63 of the pressure plate 65. Additionally, the tube structure 17 embraces the lance 73 in the manner previously described in relation to earlier embodiments.

It will be understood that contact between the everting portion 33 of the tube structure and the contact face 63 may be indirect contact in that there is a film of resin therebetween.

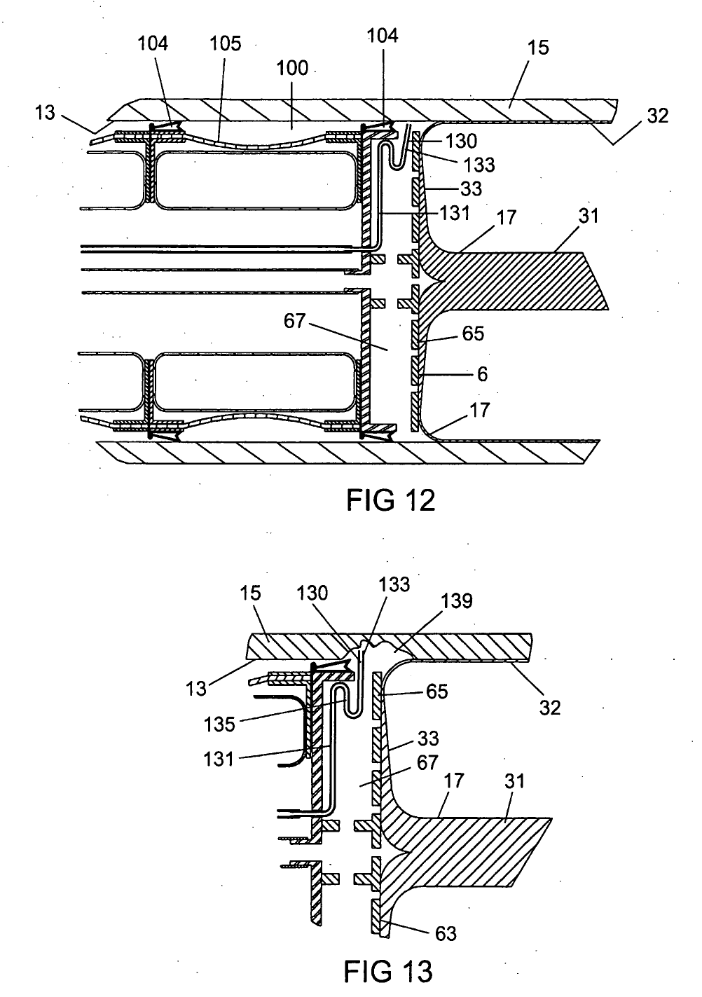

The installation head 21 may be equipped with a mechanism 130 for extracting air from cavities which might exist on the upper part of the top part of the interior surface 13 of the pipeline. Such an arrangement is incorporated in the embodiment illustrated in FIGS. 12 and 13 and includes a suction line 131 having a suction end 133. The suction line 131 adjacent the suction end 133 is configured at 135 to function as a spring arrangement biasing the suction end to an outermost condition projecting beyond the periphery of the body so as to be capable of entering cavities in the top section of the pipeline 15, as illustrated in FIG. 13 where it is seen that the suction end 133 has entered cavity 139. Normally, the suction end 133 is retained in a retracted condition as shown in FIG. 12, by virtue of contact with the interior surface 13 of the pipeline 15. However, when the suction end 133 encounters a cavity (such as cavity 139 as shown in FIG. 13), the suction end 133 can project outwardly and enter the cavity.

The suction end 33 is slightly offset from normal to the surface 13 of the pipeline, with the orientation being away from the direction of movement of the installation head, so as to avoid jarring or catching on the pipeline surface 13.

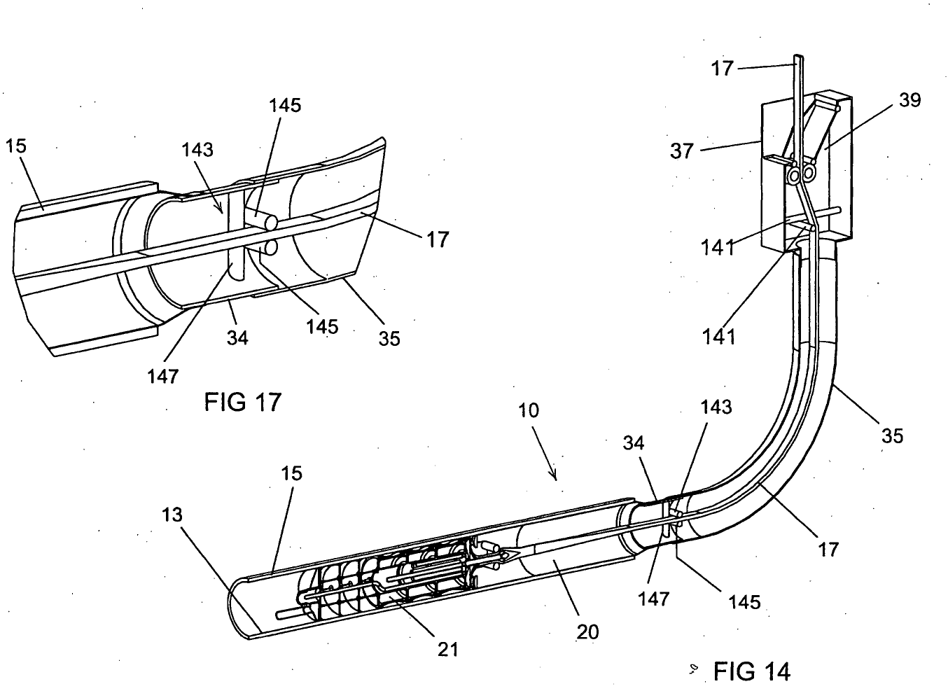

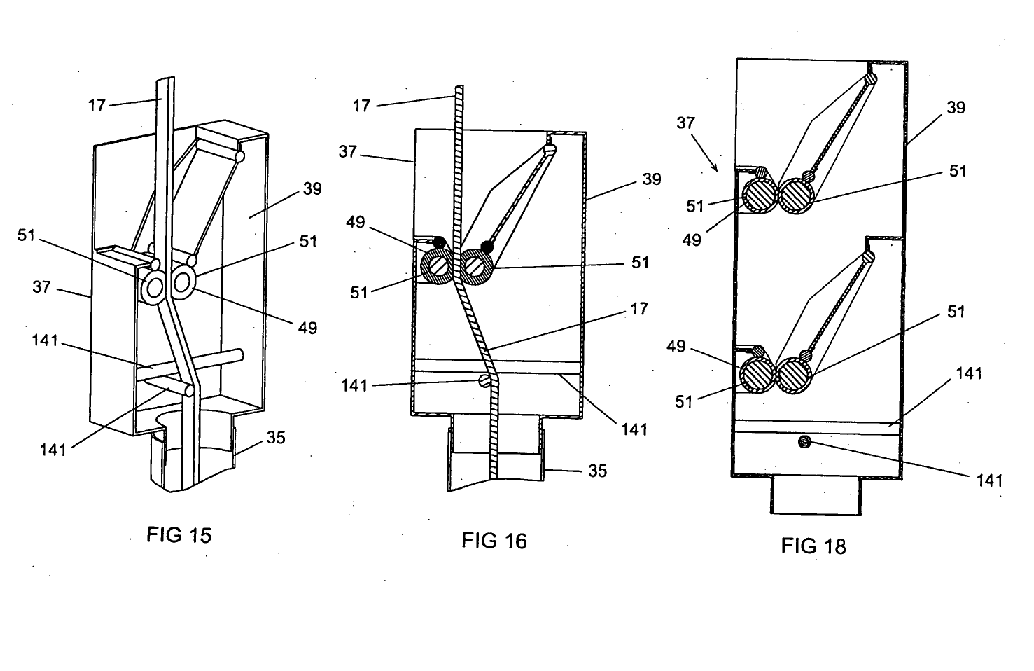

Referring now to FIGS. 14 to 17, there is shown apparatus 10 according to a further embodiment for installing a liner 11 onto the interior surface 13 of a pipeline 15.

The apparatus according to this embodiment is similar to the apparatus 10 according to the first embodiment, and so corresponding reference numerals are used to identify corresponding parts, where appropriate. In this embodiment, the delivery chamber 39 incorporates guide rollers 141 against which the collapsed tube structure 17 engages. The guide rollers 141 assist tracking of the tube structure 17 as it enters the delivery duct 35.

A roller assembly 143 is provided adjacent the end of the delivery duct 35 for the purposes of aligning the tube structure prior to entry thereof into the installation duct 34. The roller structure 143 comprises a pair of rollers 145 between which the collapsed tube structure 17 passes, with the longitudinal side portions 18, 19 of the collapsed tube structure in engagement with the rollers 145. The roller assembly 143 incorporates a lateral guide roller 147 against which one of the longitudinal edges of the collapsed tube structure 17 engages. The guide roller 143 assembly assists with lateral tracking of the collapsed tube structure as it enters the installation duct 34.

Referring now to FIG. 18 of the drawings, there is shown a delivery chamber 39 for an installation apparatus according to a still further embodiment. The delivery chamber 39 for this embodiment is similar to the delivery chamber of the previous embodiments, with the exception that it incorporates two fluid seal mechanisms 49, rather than one such fluid seal mechanism as was the case with the earlier embodiment.

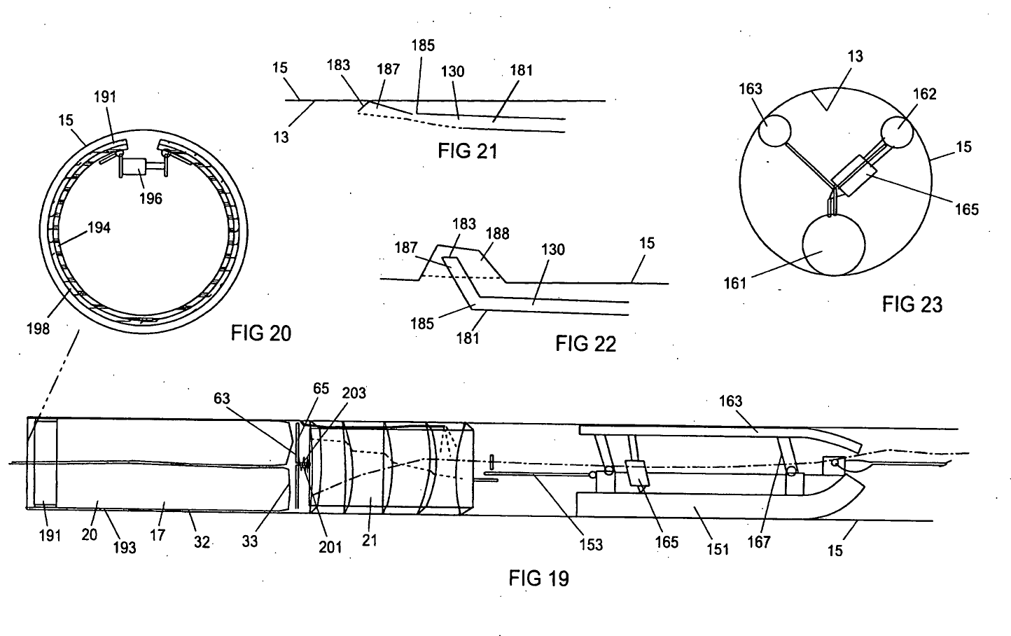

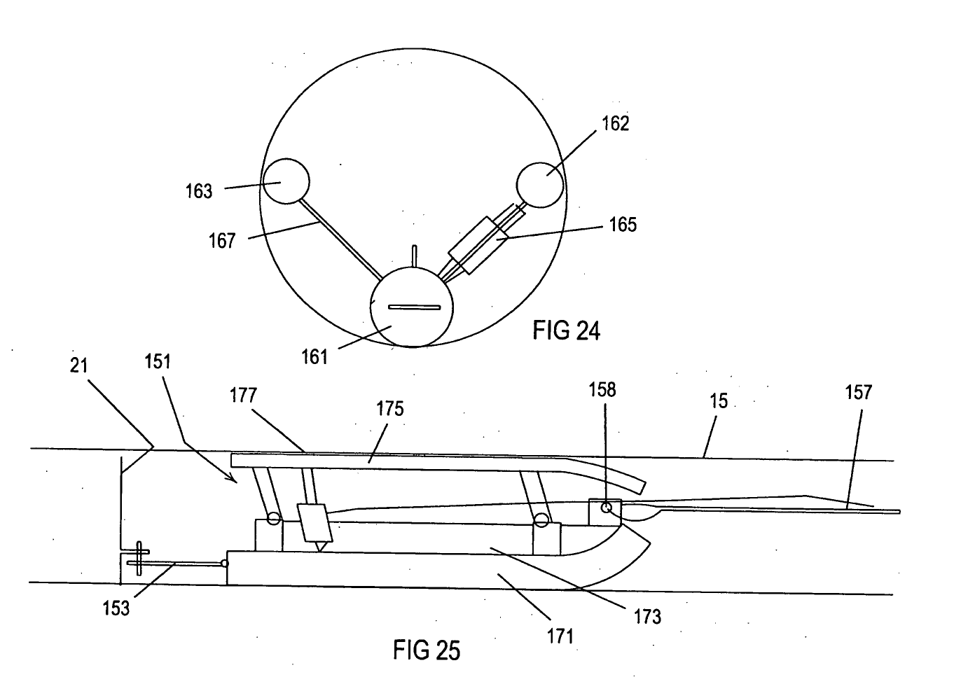

Referring now to FIGS. 19 to 25 of the drawings, there is shown installation apparatus 10 according to a still further embodiment. Again, where similarities exist with earlier embodiments, corresponding reference numerals are used to identify corresponding parts. The installation apparatus 10 according to this embodiment comprises an installation head 21 somewhat similar to the installation head of the first embodiment. In the first embodiment, the installation head 21 was described as being drawn along the pipeline 15 by a towline. In certain applications, the installation head 21 may be advanced not by a towline but rather by a driving force applied to it by the everting tube structure 17. Specifically, inflation fluid pressure, which is introduced into chamber 20 within the tube structure for causing eversion thereof and also for pressing the outer portion 32 of the tube structure into intimate contact with interior surface 13 of the pipeline 15, may be sufficient to apply a driving force to the installation head 21 through the pressure plate 65 which the everting tube structure 17 contacts. In such circumstances, there may be a need to have a mechanism for retarding the rate at which the installation head 21 advances under the influence of the fluid pressure applied through the everting tube structure 17. For this purpose, the installation head 21 according to this embodiment incorporates a brake sled 151. The brake sled 151 is located ahead of the installation head 21 and is connected thereto by way of a rigid coupling 153 for transference of a retarding force from the brake sled 151 to the installation head 21.

The brake sled 151 is adapted to frictionally engage the interior surface 13 of the pipeline 15 so as to provide the retarding force. The retarding force can be selectively varied by regulating the extent of frictional engagement with the interior surface 13 of the pipeline 15, as will be explained shortly. Furthermore, the retarding force is also regulated by having a mechanism for driving the brake sled 151, the arrangement being that the rate of advancement of the brake sled 151 (and hence the installation head 21 to which it is rigidly coupled) can be controlled by selectively varying the driving force applied to the brake sled. In other words, the rate at which the brake sled 151 and installation head 121 advance in unison is determined by a balance between: (1) the force applied to the installation head 21 through the everting tube structure 17 by the inflation fluid; (2) the driving force applied to the brake sled; and (3) the retarding force exerted on the brake sled 151 through frictional engagement with the pipeline 15.

In this embodiment, the brake sled 151 is driven by applying a towing force thereto through a towline 157, one end of which is coupled to the brake sled at coupling point 158 and the other of which is connected to a hauling mechanism such as a winch (not shown).

The brake sled 151 comprises three skid members 161, 162 and 163, each adapted to be located in sliding engagement with the interior surface 13 of the pipeline 15. Skid member 161 functions as the base of the brake structure 151 and travels along the bottom of the pipeline 15. The skid members 162 and 163 are supported on base skid member 161 by booms 165, 167. Boom 165 incorporates an adjustment mechanism 169 for selectively varying the effective length thereof and thus the relative position of skid member 162. In this way, the spacing between the three skid members 161, 162 and 163 can be varied, thus regulating the radial positioning of the skid members and consequently the force with which they frictionally engage the interior surface 13 of the pipeline 15.

In this embodiment, base skid member 161 comprises a tubular member 171 filled with ballast material such as lead. The leading end of the tubular member is upturned, and a longitudinal web 173 is provided along the length of the tubular member.

Skid members 162, 163 each comprise an elongate element 175 being in-turned at the leading end thereof. Each elongate element 175 is provided with a covering 177 formed of friction material (such as tyre tread) for the purpose of enhancing frictional resistance with the interior surface 13 of the pipeline 15.

The installation head 21 according to the embodiment also incorporates a suction mechanism 130 for extracting air from cavities which might exist on the upper part of the interior surface 13 of the pipeline 15, as was the case with the first embodiment. The suction mechanism 130 in this embodiment comprises a suction line 181 having a suction end 183. The suction line 181 adjacent the suction end 183 incorporates a formation 185 which causes the outer end section 187 of the suction line 181 to deflect laterally to extend beyond the periphery of the installation head so as to be capable of entering cavities in the upper part of the pipeline 15, as shown in FIG. 22 of the drawings where the end section 187 is shown in cavity 188. The formation 185 in the suction line 181 establishes a “kink” in the suction line 181 when the outer section 187 is not deflected laterally, as shown in FIG. 21 of the drawings. The “kink” functions as a valve for the purposes of stopping, or at least retarding, flow into the suction line 181 in circumstances where air extraction is not necessary (ie. where there is no cavity).

This embodiment also incorporates the feature of a clamping seal mechanism 191 for clampingly retaining the outer tube portion 32 in sealing engagement with the interior surface of the pipeline 15. This is for the purpose of blocking rearward flow of resin to ensure that there is an ample coating of resin between the interior surface 13 of the pipeline 15 and the outer tube portion 32 in the section 193 thereof immediately rearward of the everting portion 33 of the tube structure 17. With this arrangement, the resin is contained at one end by the clamping seal mechanism 191 and at the other end by the pressure plate 65 and the annular seal 104 therearound. This ensures that there is ample resin between the interior surface of the pipeline 15 and the section 193 of the liner rearward of the everting portion 33 for bonding purposes.

The clamping seal mechanism 191 comprises a support 194 of split ring construction, incorporating a mechanism 196 for expanding and contracting the ring. The outer surface of the support 194 is provided with a layer 198 of deformable material, such as rubber, for the purposes of accommodating irregularities in the surface against which it bears. The split-ring support 194 is moved into a contracted condition so as to allow it to be fitted in position in the pipeline 15. It is then expanded to clampingly engage against the interior surface of the pipeline 15, with the outer tube portion 32 clamped therebetween.

In the installation head 21 used in the first embodiment, the pressure plate 65 defining the contact face 63 was rigidly supported within the installation head. In this embodiment, the pressure plate 65 is supported on an elastic suspension system 201 incorporating a spring 203. This allows the pressure exerted on the pressure plate 65 through the everting tube portion 33 by the inflation fluid to be monitored and operating systems adjusted accordingly. For example, the rate of delivery of resin to the resin chamber 67 can be varied by regulating the resin delivery pump according to operating demands as determined by the pressure. In this embodiment, this arrangement involves use of a proximity switch (not shown) which detects deflection of the pressure plate 65 to a prescribed extent in response to pressure exerted thereon, so as to initiate delivery of resin to the resin chamber 67. In this way, delivery of resin to the resin chamber 67 can be stopped, or at least reduced, in the event of separation between the contact face 63 of the pressure plate 65 and the everting portion 33 of the tube structure 17. The resin flow can recommence once the everting portion 33 of the tube structure 17 moves into appropriate contact with the contact face 63, as determined by deflection of the pressure plate 65.

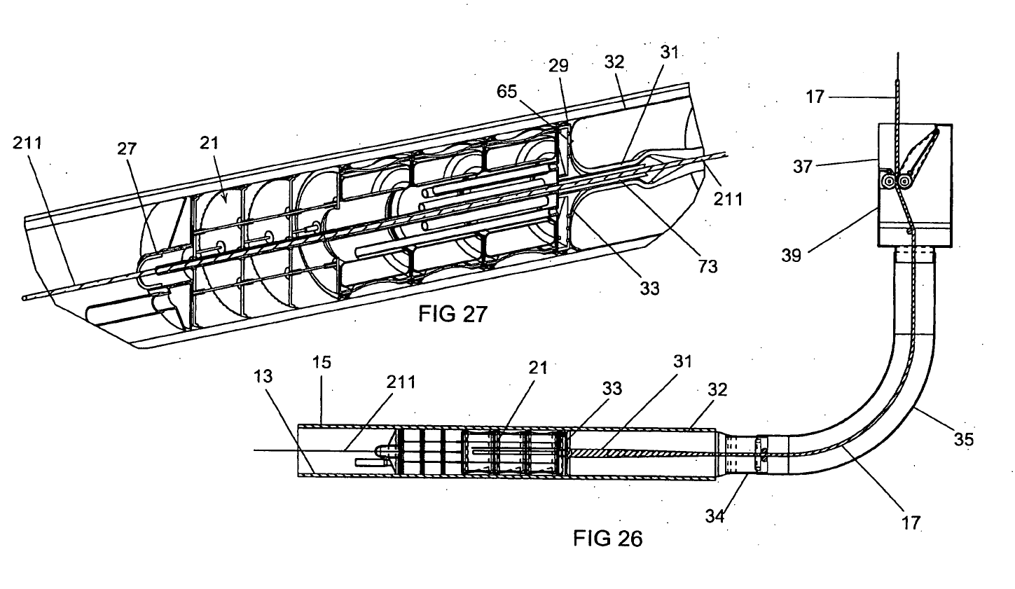

The embodiment shown in FIGS. 26, 27 and 28 is directed to apparatus 10 according to a still further embodiment for installing a liner 11 onto the interior surface 13 of a pipeline 15. The apparatus 10 according to this embodiment is similar in most respects to the apparatus 10 according to the first embodiment and corresponding reference numerals are used to identify corresponding parts. In this embodiment, there is provision for hauling the collapsed tube structure 17 along the delivery duct 35 and installation duct 34, as well as the pipeline 15, to augment the advancing movement effected by the inflation pressure.

The haulage system utilises an installation cable 211 in the form of a haul rope. The haul rope 211 extends axially through the tube structure 17, such that the tube structure binds to the rope when the tube structure is in its collapsed condition. While not apparent from the drawings, in this embodiment the tube structure comprises an inner layer 17a and an outer layer 17b, with the rope 211 extending axially along the tube structure within the inner 211 layer. The rope 211 is inserted into position in the tube structure 17 at the time of manufacture of the tube structure 17.

The rope 211 is hauled by an appropriate hauling mechanism, such as a winch or winding drum (now shown).

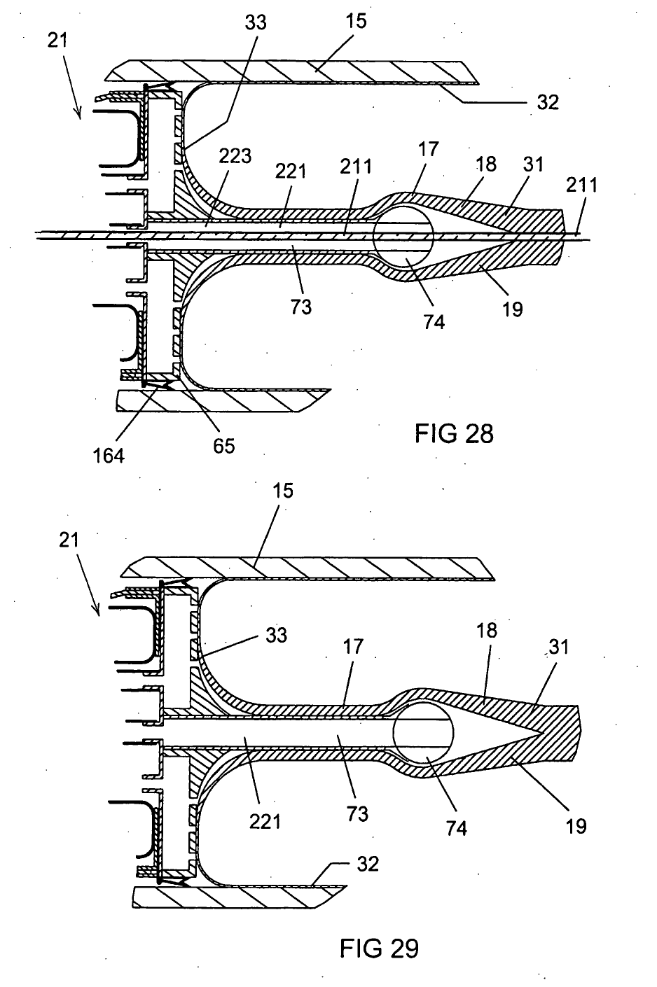

In this embodiment, the lance 73 projecting rearwardly from the pressure plate 65 terminates at protrusion 74 which is of generally spherical configuration. It may be advantageous for the lance 73 to have some lateral flexibility. The protrusion 74 is received in the collapsed interior of the tube structure 17 between the longitudinal side portions 18, 19 thereof as the tube structure approaches the installation head. The lance 73 has a passage 221 extending axially therethrough. The passage 221 is dimensioned to receive the rope 211 with a clearance space 223 therebetween, as best seen in FIG. 28 of the drawings. With this arrangement, the lance 73 assists in separating the haul rope 211 from the collapsed tube structure 17, with the rope 211 passing through the lance structure 73 and the longitudinal portions 18, 19 moving to opposed sides of the lance as they approach the contact face 63 of the pressure plate 65, also as best seen in FIG. 28 of the drawings.

The clearance space 223 provides a passage through which any air within the collapsed tube structure 17 can escape.

The seal established at the interface between the protrusion 74 and the tube structure 17 sliding thereover, prevents migration of resin from the resin chamber 67 and the region around the lance 73 beyond the protrusion 74 and into contact with the haul rope 211 and also into the passage 221. Presence of resin on the haul rope 211 and in the passage 221 would be most undesirable, as it could impede separation of the haul rope from the tube structure 17 and also movement of the haul rope along the passage 221.

Because the collapsed tube structure 17 binds to the rope 211 and is separated therefrom through interaction with the lance 73, the haul rope and tube structure advance at the same rate along the delivery duct 35 and installation duct 34.

Because the haul rope 211 is drawn through the central passage 221 within the lance 73 and is connected to a hauling mechanism such as a winch, it moves independently of the installation head 21.

While the embodiment shown in FIGS. 26, 27 and 28 is designed specifically for use with a tube structure 17 incorporating a haul rope 211, it can also be used with a tube structure which does not incorporate such a haul rope. Use of the installation head according to the embodiment with a tube structure 17 without a haul rope is illustrated in FIG. 29 of the drawings.

In the embodiments described previously, the tube structure 17 was delivered to installation head 21 in a collapsed condition as shown in FIG. 9 of the drawings.

It has been found that there is an advantage in folding the tube structure 17 into a collapsed condition involving one or more re-entrant folds. Such a folded condition is illustrated in FIG. 30 of the drawings, where the tube structure 17 comprises an inner tubular layer 17a and an outer tubular layer 17b. In this embodiment, the inner tubular layer 17a is of a resin absorbent material such as fibreglass fabric, and the outer tubular layer 17b is of a material appropriate for the intended purpose, such as polypropylene.

The tube structure 17 is folded into a collapsed condition involving two re-entrant folds 231, 232 disposed between two longitudinal side portions 18, 19. With this arrangement, the re-entrant folds each extend inwardly from one longitudinal edge of the collapsed tube structure. Again, it should be noted that the longitudinal portions 18, 19 are illustrated in FIG. 30 in a spaced apart condition, however, in practice they would be in facing contact.

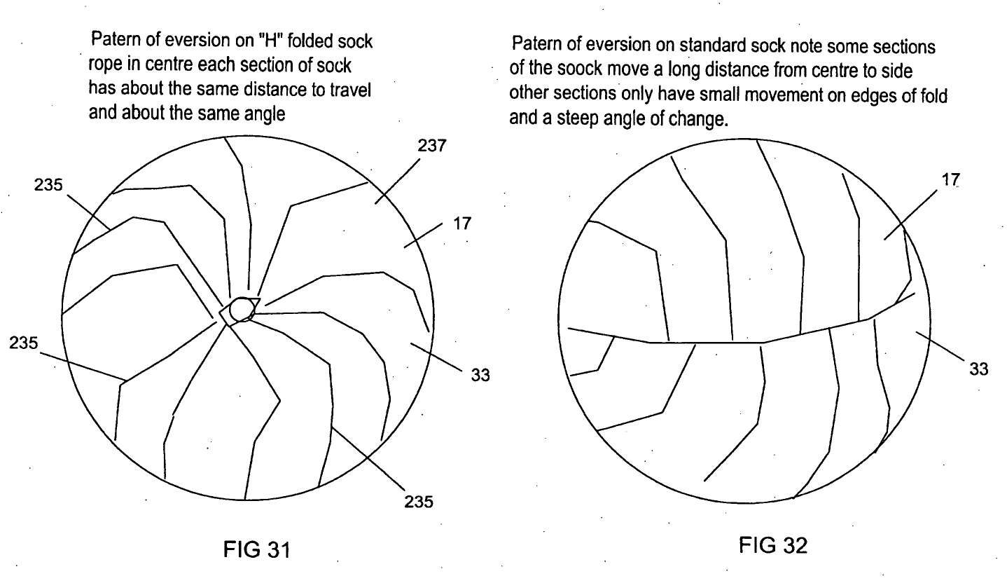

Such a folding structure has been found to be particularly advantageous in the manner in which it undergoes eversion. This will be explained with reference to FIGS. 31 and 32, where FIG. 31 is a schematic view of the everting portion 33 of the collapsed tube structure shown in FIG. 30, and FIG. 31 is a view of the everting portion of the collapsed tube structure shown in FIG. 9. It can be seen from FIG. 31 that the tube structure 17 everts in a nearly even manner, with imaginary chords 235 along the surface 237 of the everting portion travelling about the same distance and in a relatively even direction radially in moving from the collapsed condition to the assembled condition. By comparison, it is evident from FIG. 32 that the collapsed tube structure shown in FIG. 13 does not evert in such an even fashion.

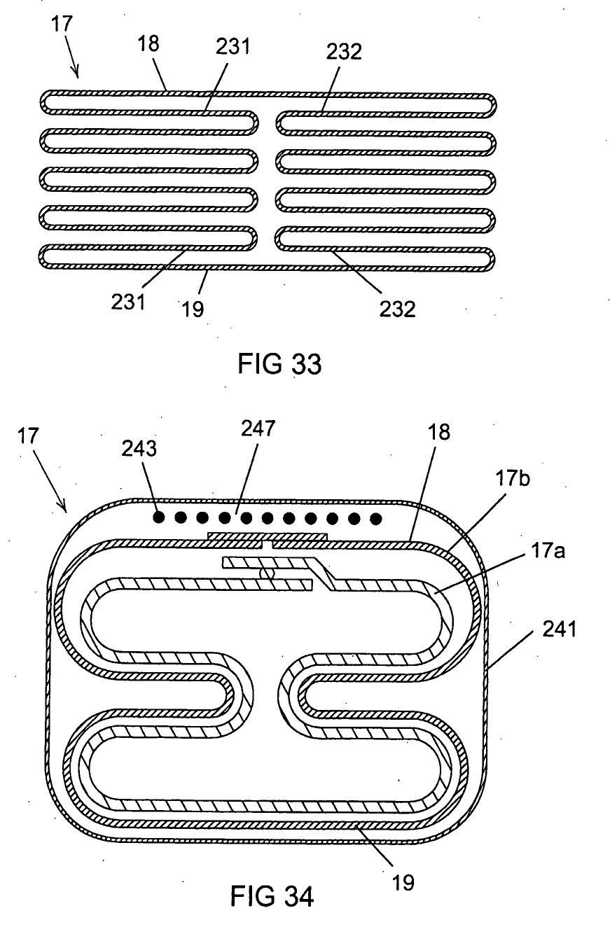

The collapsed tube structure 17 shown in FIG. 30 has two re-entrant folds 231, 232. It should be appreciated that other folding patterns involving re-entrant folds are possible. For example, FIG. 33 illustrates a collapsed tube structure 17 involving a plurality of re-entrant folds 231, 232 extending inwardly from the longitudinal edges thereof.

Another folding pattern, which is not illustrated, may involve radially extending re-entrant folds circumferentially spaced around the tube structure. In such a case, the collapsed tube structure would have a somewhat star configuration.

Referring now to FIGS. 34, 35 and 36, there is shown a construction of the tube structure 17 having provision for extraction of air contained therein. The arrangement comprises a sleeve 241 formed of a flexible plastic material or any other appropriate material impermeable to air. The sleeve 241 encases the collapsed tube structure 17. FIG. 34 illustrates the arrangement in a very schematic fashion which does not truly resemble the actual appearance. In reality, the tube structure 17 is collapsed such that the longitudinal portions 18, 19 are pressed one against the other in facing contact, with the re-entrant folds compressed therebetween. Furthermore, the sleeve 241 tightly encases the collapsed tube structure 17. Longitudinal spacer elements 243 extend axially along the collapsed tube structure 17 between longitudinal portion 18 and the encasing sleeve 241.

In one arrangement, the longitudinal elements 243 comprise a bundle of fibreglass strands. The longitudinal elements 243 cooperate with the collapsed tube structure and the encasing sleeve to establish an axial path 247 along which air can be extracted. Typically, the axial air path 247 is established with the bundle of fibreglass strands. The axial path 247 communicates with suction source (not shown) at the trailing end of the collapsed tube structure 17.

In another arrangement, the longitudinal elements 243 comprise flexible tubes defining paths for extraction of air, with the tube side walls being perforated at appropriate locations for air ingress. As with the first arrangement, the tubes communicate with a suction source or to atmosphere.

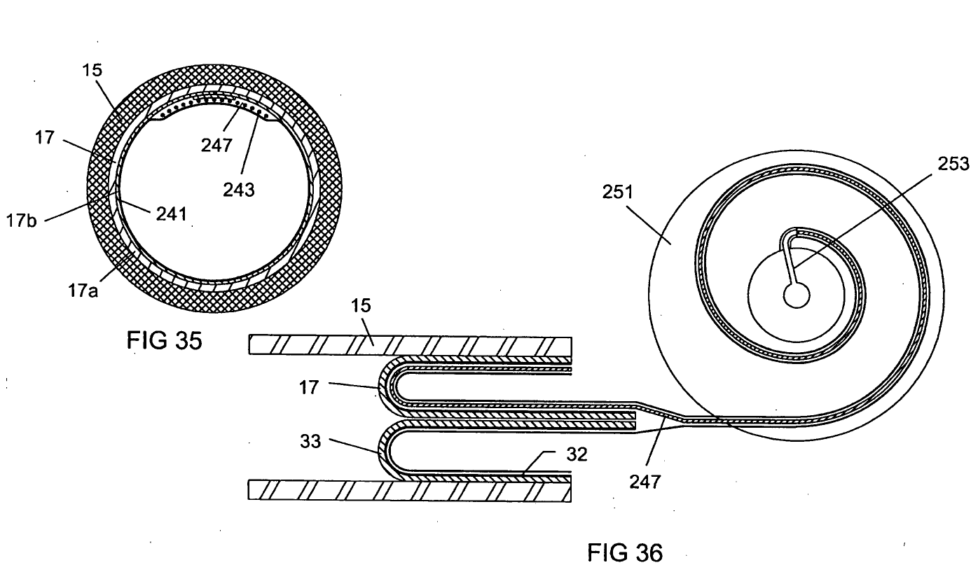

As shown in FIG. 35, the collapsed tube structure 17 is delivered from a reel 251 about which it is wound. The reel 251 has provision 253 for coupling the end of the air path 247 to the suction source.

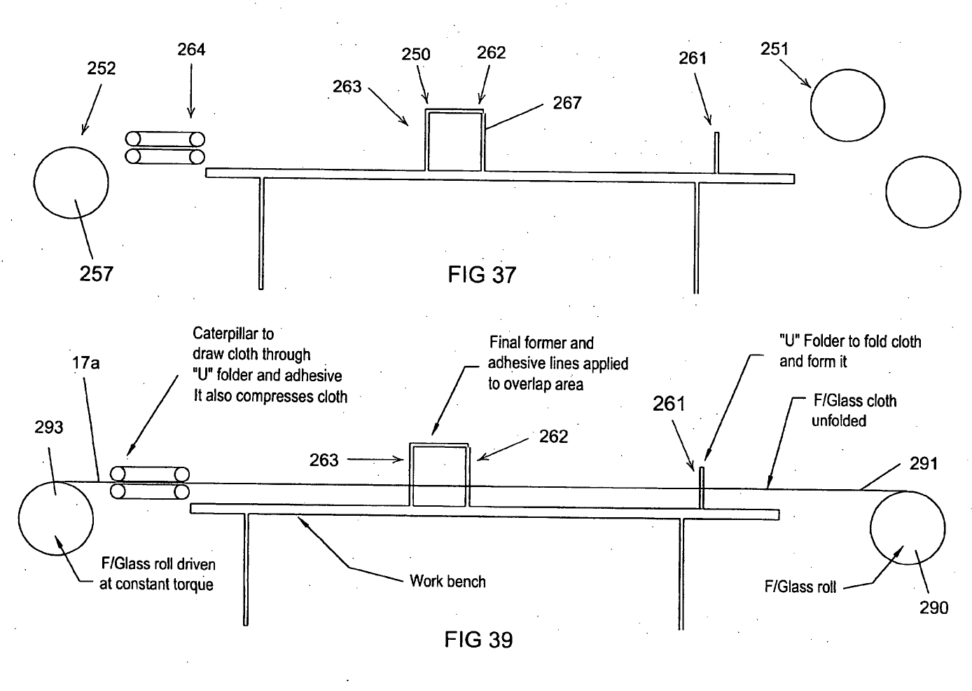

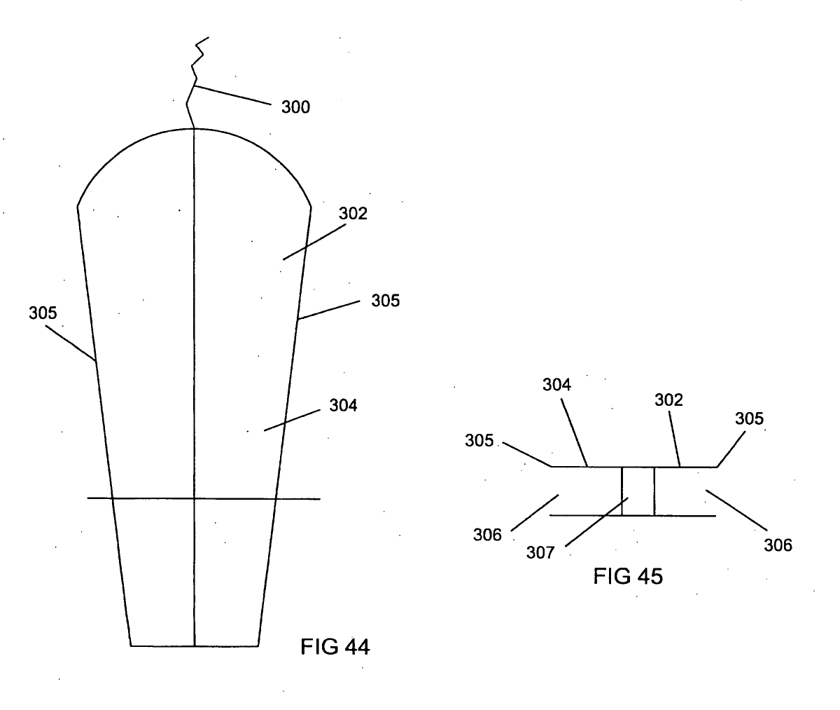

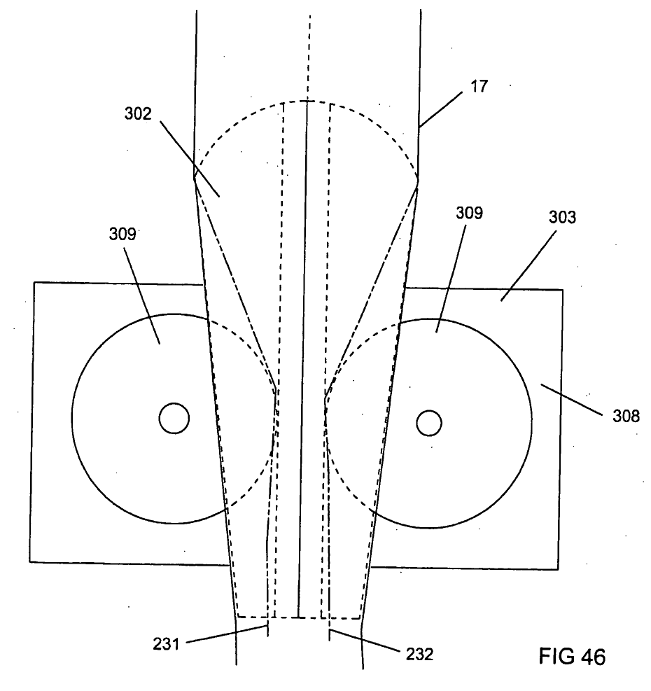

Various embodiments described previously utilise a tube structure 17 having an inner layer 17a and an outer layer 17b. FIGS. 37 to 48 of the drawings illustrate an arrangement for conveniently constructing such a tube structure 17.

The arrangement comprises an assembly line 250 at which various operations of the construction process can be performed. The assembly line 250 has a first end 251, a second end 252, and a construction path extending between the first and second ends. At the first end 251, various materials used in the construction process can be delivered to the construction path from respective reels on which the materials are supplied. At the second end 253, the constructed component can be wound onto a storage reel 257. The storage reel 257 is driven to facilitate winding of the component thereonto.

The construction path has various operational stages, comprising a first forming stage 261, a second forming stage 262, a third bonding stage 263 and a fourth folding and pressing stage 264. In this embodiment, the second and third stages 262, 263 are integrated in a single unit 267.

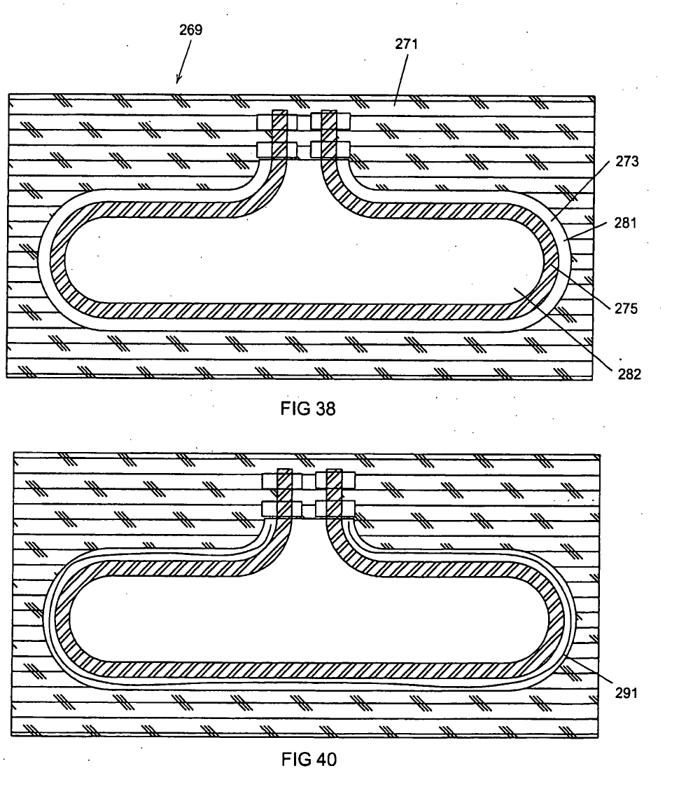

The first stage 261 involves a former 269, as shown in FIG. 38 of the drawings. The former 269 comprises a outer member 271 incorporating an aperture 273 located therein. A loop member 275 is accommodated within the aperture 273 in spaced apart relationship from the periphery thereof, such that there are two working spaces 281, 282 defined within the former 269. The space 281 is defined between the outer member 271 and the loop member 275, and the space 282 is defined within the confines of the loop member 275, as shown in FIG. 37.

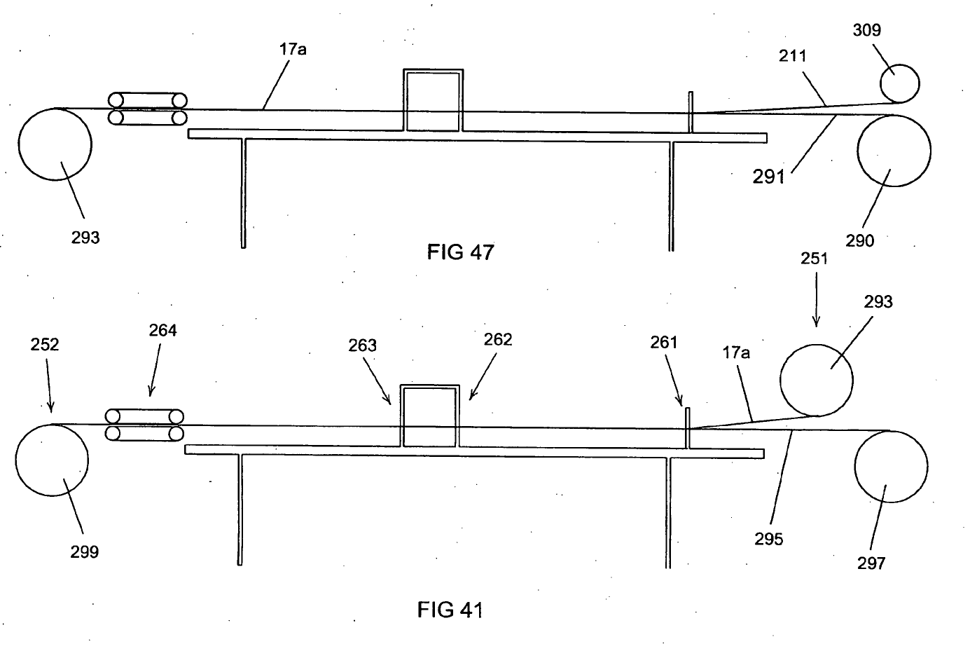

Construction of the inner layer 17a of the tube structure 17 will now be described with reference to FIGS. 39 and 40 of the drawings. A roll 290 of fibreglass material is located at the first end 251 and a web 291 of material therefrom is fed along the construction path, passing in the outer space 281 within the former 269, as shown in FIG. 40 of the drawings. In this way, the longitudinal edge portions of the web 291 of fibreglass material are turned inwardly towards each other, in the first step of the process of forming the web into a tubular configuration. From the first former 269, the web 291 (with the longitudinal sides thereof turned inwardly) continues to travel along the construction path towards a second former at second stage 262 at which the longitudinal edges are positioned one with respect to the other for bonding together. The bonding action is performed at the third bonding stage 263. For construction of the inner layer 17a, the bonding process typically involves adhesive bonding. This completes construction of the inner portion in its tubular form, and it is then wound onto a storage reel 293 at the second end 252.

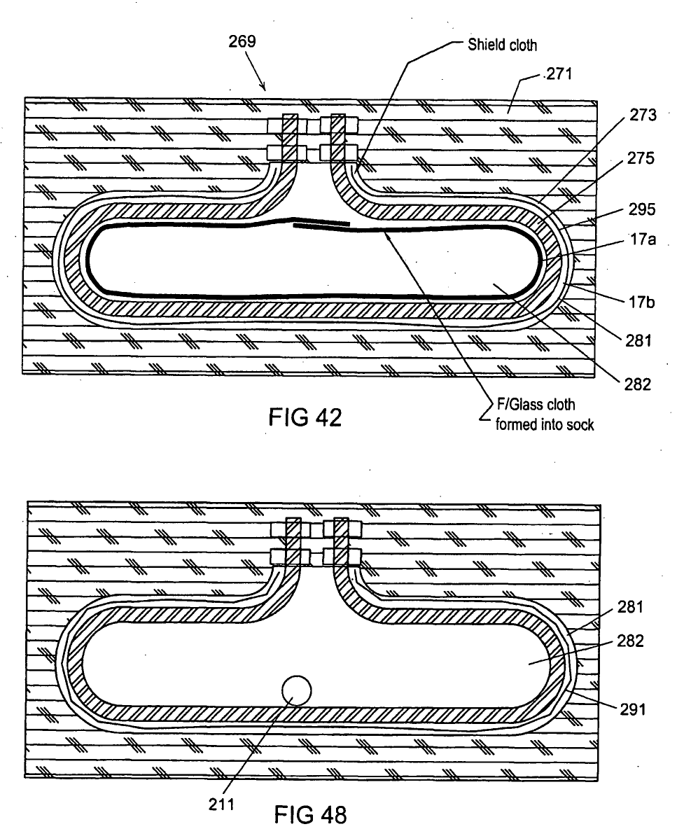

The next stage of the process involves transferring the reel 293 on which the inner layer 17a is wound to the first station 251. A web 295 of material for the outer layer 17b is to be constructed on a reel 297 also at the first station. The tubular inner layer 17a is fed into the inner space 282 within the former 269, and the web 295 of material to provide the outer layer 17b is fed into the outer space 281 within the former 269, as best shown in FIG. 42. As the materials travel through the former 269, the longitudinal side portions of the web 295 contained within the outer space 281 are turned inwardly to commence construction of the outer layer 17b in its tubular configuration. From the first former, the materials travel to the second former at station 262 at which the longitudinal edges of the web 295 are brought together and bonded one to another so as to complete construction of the outer layer 17b in its tubular configuration. This thus provides the tube structure 17 having the inner and outer portions. The bonding process in construction of the outer layer 17b typically involves plastic welding.

Where the tube structure 17 is to have a collapsed configuration as shown in FIG. 9, the construction process continues to stage 264 where the collapsed tube structure is compressed to ensure that bonded surfaces are in good contact one with the other and to also flatten the tube structure to facilitate winding onto a reel 299 at the second station.

In circumstances where the tube structure 17 is to have re-entrant folds, such as illustrated in FIGS. 30 and 33, the tube structure 17 is subjected to a folding operation. This can be conducted prior to winding of the tube structure onto the reel 299, or alternatively as a separate operation at a later stage.

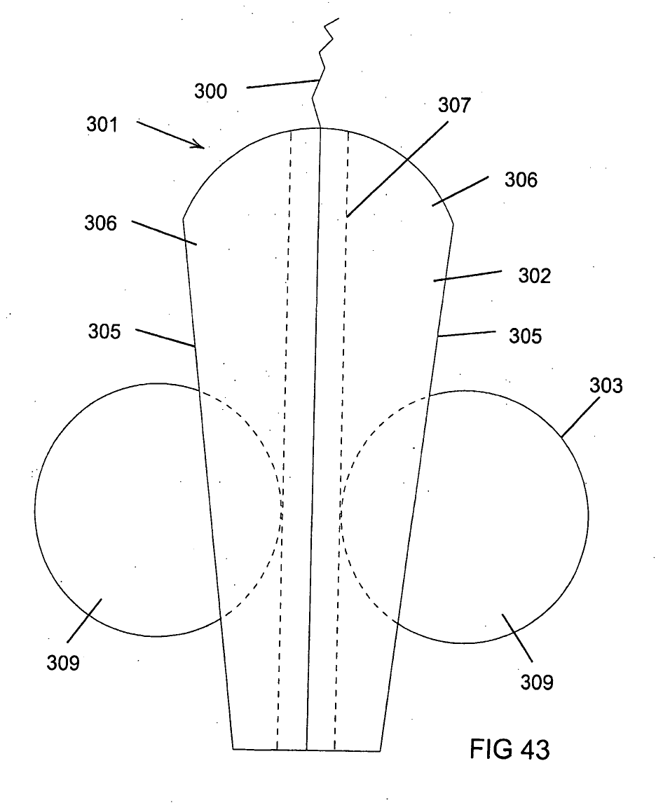

The folding operation may be performed using a folding mechanism 301 as illustrated in FIGS. 43 to 46 of the drawings. The folding mechanism 301 comprises an inner former 302 and a cooperating outer former 303. The arrangement is that the inner former 302 is positioned within the tubular structure 17 and the outer former 303 cooperates with the inner former to form the re-entrant folds 231, 232.

The inner former 302 comprises a body 304 having two opposed longitudinal sides 305, with a longitudinal channel 306 opening onto each side 305 and a central web 307 therebetween, as best seen in FIG. 45. With this arrangement, each channel 306 provides a recess into which a portion of the tubular structure 17 can be pressed to form the respective re-entrant fold.

The outer former 303 comprises a body 308 having a pair of press wheels 309 in spaced apart relationship, the spacing being slightly larger than the central web 307 defined between the two channels 306 in the inner former 302.

With this arrangement, the outer former 303 is positioned around the inner former 302, with the press wheels 309 received within the channels 306 and portions of the tubular structure 17 interposed therebetween. Relative movement of the inner and outer formers 302, 303 with respect to the tube structure 17 causes the press wheels 309 to press portions of the tube structure 17 into the recesses 306 and thereby progressively create the re-entrant folds.

Relative movement between the folding mechanism 301 and the tube structure 17 can be achieved in any appropriate way. For example, the inner former 302 may be hauled along the interior of the tube structure 17, with the outer former 303 moving along the tube structure in unison with the inner former. The inner former may be hauled in any appropriate way, such as by a cable 300 attached thereto.

In another arrangement, the folding mechanism 301 may be located at a folding station and the tube structure 17 progressively advanced through the folding station to undergo the folding operation.

Once folded the folds can be held in position by some appropriate means during storage and handling. The means of restraint are removed upon the tube structure being introduced into the rollers of the pressure chamber and are held in a collapsed position by the pressure within the chamber and the pipe as it moves down to and everts at the eversion point.

Where the tube structure 17 incorporates a haul rope 211 as described earlier in relation to the embodiment shown in FIGS. 26, 27 and 28, the haul rope 211 can be incorporated into the tube structure 17 during construction thereof. Specifically, the haul rope 211 can be positioned within the inner tubular layer 17a during its construction. This can be seen with reference to FIGS. 47 and 48 of the drawings, which illustrates construction of the inner layer 17a. The rope 211 is provided on a reel 309 and is fed into the inner space 282 within the first former 269, with the web 291 of material providing the inner layer 17a passing through the outer space 281, as shown in FIG. 48. In this way, the inner layer 17a is formed around the rope 211.

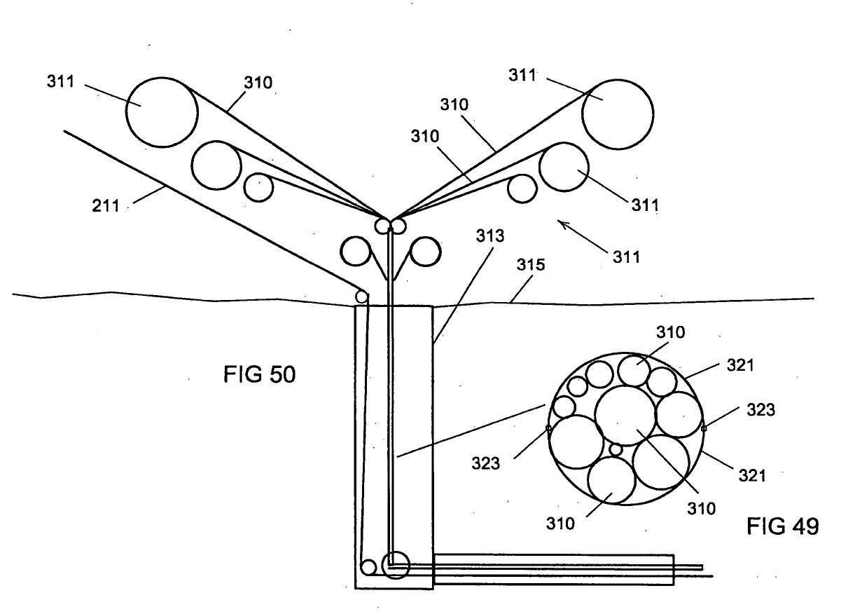

It is likely that the installation heads 21 according to the previous embodiments will require a plurality of service lines 310 for provision of services such as electrical power, resin supplies, and a winching cable, as shown in FIG. 50. The service lines 310 extend to the installation head 21 from a station 311 located exteriorly of the pipeline at the end thereof which the installation head 21 approaches during the lining operation. The station 311 accesses the underground pipeline 15 by way of access hole 313 in the ground 315. As the installation head 21 approaches the end, the necessary length of each service line progressively reduces and so surplus service line is wound onto reels. In certain circumstances, it may be advantageous to contain that lengths of the surface lines within the pipeline within a containment sleeve 320, for the purposes of avoiding tangling and other interference between the various surface lines. This can be achieved by way of the containment sleeve 320 as illustrated in FIG. 49 of the drawings. The containment sleeve 320 may be formed of a plurality of sleeve sections 321 adapted to be zipped one to another by zippers 323 to form the containment sleeve. The sleeve sections 321 can be progressively unzipped as the sleeve 320 approaches the station 311, thereby allowing the various service lines 310 to separate for winding onto their respective reels 311. The containment sleeve 320 constructed of sleeve sections zipped together may be in the form of a shroud of the type described in U.S. Pat. No. 6,196,766. The haul rope 211 (if employed) is not accommodated in the containment sleeve 320.

In the various embodiments described, each chamber 123 was adapted to contain air. In an alternative embodiment, the trailing chamber 123 may be adapted to receive and contain nitrogen (or another appropriate gas or gaseous mixture) to displace air and thus provide an inert environment to which the resin is exposed as it is subsequently applied.

In the embodiments described, the liner has been applied directly to the interior surface 13 of the pipeline 15. There may be circumstances where it is beneficial to apply a substrate to the interior surface 13 of the pipeline 15 prior to placement of the liner. This can be particularly advantageous in circumstances where the interior surface is in a bad state of repair. The substrate may include repair and/or sealing compounds or a layer of material for enhancing the engagement of the liner with the interior surface 13.

Where a substrate is to be applied to the interior surface 13, additional holding chambers 100 are provided for such a purpose. The substrate substance would be applied to the interior surface 13 of the pipeline in a similar fashion to the manner in which resin is applied; that is, the substrate would be presented to and wiped onto the interior surface 13 of the pipeline 15. The or each additional chamber used in the installation of the substrate would, of course, need to be ahead of the chambers utilised for the delivery of resin for the purposes of bonding the liner in position. The substrate material may be vibrated in order to optimise its deposition onto the interior surface of the pipeline.

The substrate material may be aerated.

In certain applications, it may be useful for the holding chambers 100 to be divided into segments (for example, an upper segment and a lower segment), with the segments containing resin of different characteristics. There may, for example, be situations where it is desirable to have the upper region of the rigid liner constructed using resin which provides one characteristic to that region, and a lower region constructed using another resin to provide that region with a different characteristic. This may be useful in a situation where the lower region of a liner needs to have good wear resistance characteristics and the upper region is required to have resistance to the corrosive effects of gases contained within the pipeline.

In the embodiments described previously, the lining applied by apparatus according to the various embodiments comprise a liner extending continuously along the length of the pipeline or at least along an extended portion of the pipeline. There may be occasions where there is localised deterioration of a pipeline which does not necessitate that the entire length of the pipeline, or an extended section of the pipeline length, be lined. In such circumstances, it may be advantageous to merely patch localised areas within the pipeline. This can be achieved by forming the tube structure as a membrane with one or more discrete liner portions of resin absorbent material positioned thereon at appropriate locations such that upon eversion of the tube structure the portions of resin absorbent material are applied to the internal surface of the conduit at locations where patching is required. With this arrangement, the tube structure is somewhat similar to the tube structure of previous embodiments in that it comprises inner and outer layers, with the exception that the inner layer is releaseably attached to the outer layer and is also discontinuous in the sense that it comprises discrete sections each corresponding to one of the localised areas requiring patching. Resin is applied to the or each discrete liner portion upon eversion of the tube structure, so that the discrete liner portion is bonded to the internal surface of the pipeline at the relevant localised area. Once the resin had cured sufficiently, the membrane defined by the second layer is withdrawn, leaving the liner portions in position as patches within the pipeline. Alternatively, the membrane may be sacrificial.

With this arrangement, resin delivery is appropriately controlled so that it is applied where necessary to the liner portions to provide the patches, without unnecessary application in other areas where not required.

The tube structure is constructed with the discrete portions of resin absorbent material constituting the first layer positioned at appropriate locations on the membrane which constitutes the second layer of the tube structure. The locations for positioning of the discrete portions of resin absorbent material would be determined through a reconnaissance operation or other analysis of the pipeline as appropriate.

There may also be occasions where it is necessary to apply a patch as a strip extending along the longitudinal extent of the pipeline, or at least along part of the length thereof, without needing to line the entire pipeline. This can be achieved in a similar fashion to the patching operation described above, the only difference being that a strip of resin absorbent material constituting the first layer is positioned at an appropriate location on the membrane constituting the second layer of the tube structure. The strip is then applied to the pipeline in a similar fashion to the discrete patches as described above.

From the foregoing, it is evident that the present embodiments provide a simple yet highly effective arrangement for ensuring that the everting tube is properly “wet-out” bonded to the pipe during installation of the liner 11.

Improvements and modification may be incorporated without departing from the scope of the invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. Apparatus for lining an internal surface of a conduit, comprising a body adapted to be progressively moved along the conduit for installing a flexible tube structure onto the internal surface, the flexible tube structure undergoing eversion within the conduit, the body presenting a contact surface against which the tube acts during eversion thereof.

2. Apparatus according to claim 1 wherein the contact surface has means for delivery of an agent to the everting portion of the tube structure.

3. Apparatus according to claim 2 wherein the means for delivery of the agent comprises a plurality of ports in the contact surface, the ports communicating with a supply of the agent.

4. Apparatus according to claim 3 wherein the contact surface is defined by a plate having apertures therein incorporating the ports and the plate is either rigidly supported or elastically supported.

5. (canceled)

6. (canceled)

7. Apparatus according to claim 2 wherein the agent comprises a curable resin and the tube structure comprises a resin absorbent material.

8. Apparatus according to claim 7 wherein the plate has a face defining the contact surface and an opposed face thereof providing a boundary for a resin chamber from which resin may be delivered to the contact face by way of the apertures therein.

9. Apparatus according to claim 8 wherein the body has provision for applying resin to the surface onto which the liner is presented.

10. Apparatus according to claim 9 wherein the body comprises a circumferential chamber which is exposed to the surface and which contains resin which is wiped on the surface.

11. Apparatus according to claim 10 wherein the circumferential chamber is defined between two spaced apart seals for sliding and sealing contact with the surface, and an inner wall extending between the two seals.

12. Apparatus according to claim 11 wherein the inner wall is defined by a flexible membrane.

13. Apparatus according to claim 12 wherein the body further comprises one or more additional chambers one adjacent another axially spaced along the body.

14. Apparatus according to claim 1 wherein the body incorporates a leading section for performing preparatory work on the interior surface of the conduit.

15. Apparatus according to claim 1 wherein the forward portion of the apparatus incorporates a collection means for collecting debris within the conduit prior to installation of the liner.

16. Apparatus according to claim 1 wherein the tube structure is delivered to the body in a collapsed condition and opened during eversion thereof.

17. (canceled)

18. Apparatus according to claim 16 wherein the collapsed condition involves at least one re-entrant fold.

19. Apparatus according to claim 17 wherein an installation cable is provided in the collapsed tube structure for assisting axial movement thereof while in the collapsed condition.

20. Apparatus according to claim 16 further comprising means for establishing a “wet-out” region within the collapsed tube structure prior to eversion thereof.

21. Apparatus according to claim 20 wherein said means comprises a lance structure projecting outwardly of the contact surface and terminating at a free end, with the collapsed tube structure embracing the lance structure so that the lance structure is inserted in the tube structure as it approaches the contact face for eversion thereagainst.

22. Apparatus according to claim 21 wherein the free end of the lance structure is configured to spread the collapsed wall of the tube structure to create a cavity to receive the resin.

23. Apparatus according to claim 1 wherein the body is caused to move along the conduit under the application of a driving force.

24. Apparatus according to claim 23 wherein the driving force comprises pressure applied to the body through the everting tube structure.

25. Apparatus according to claim 24 wherein the driving force further comprises a towing force applied to the body.

26. Apparatus according to claim 23 further comprising means for applying a retarding force to the body to hold up a column of fluid within the resin pressure chamber.

27. Apparatus according to claim 26 wherein the retarding force is applied by way of a brake sled operatively connected to the body and in friction engagement with the interior surface of the conduit.

28. Apparatus for lining a conduit comprising a body adapted to be progressively moved along the conduit for installing a flexible liner onto the interior surface of the conduit or any substrate applied thereto, the flexible liner comprising a tube structure undergoing eversion within the conduit, the tube comprising resin absorbent material, the body presenting a contact surface against which the tube structure acts during eversion thereof, the contact surface having means for delivery of a curable resin to the everting portion of the tube structure.

29. (canceled)

30. A method of lining a conduit comprising:
providing a tube as a liner for the conduit;
everting the tube into the conduit whereby the tube has an inner tube portion, an outer tube portion and an everting portion extending between the inner and outer tube portions; and
causing the exposed face of the everting portion of the tube to slidably engage a contact surface at which a curable resin is presented to the everting face of impregnation thereof.

31. A method according to claim 30 further comprising sensing and/or monitoring selected conditions associated with installation of the liner and varying the installation process as necessary in response to such conditions.

32. (canceled)

33. (canceled)

34. (canceled)

35. (canceled)

36. (canceled)
